(19) United States
(12) Patent Application Publication
(10) Pub. No.: US 2020/0068160 A1
(43) Pub. Date: Feb. 27, 2020

(54) ELECTRONIC APPARATUS AND METHOD OF CONTROLLING THE SAME

(71) Applicant: SAMSUNG ELECTRONICS CO., LTD., Suwon-si (KR)

(72) Inventors: Kyuhyun CHO, Suwon-si (KR); Hoyeon KIM, Suwon-si (KR); Sangyoung LEE, Suwon-si (KR); Hyungsun LEE, Suwon-si (KR); Heeseok JEONG, Suwon-si (KR)

(73) Assignee: SAMSUNG ELECTRONICS CO., LTD., Suwon-si (KR)

(21) Appl. No.: 16/541,932

(22) Filed: Aug. 15, 2019

(30) Foreign Application Priority Data
Aug. 27, 2018 (KR) 10-2018-0100454

(51) Int. Cl. H04N 5/44; G06F 3/01; G06F 3/16

(52) U.S. Cl. CPC H04N 5/4403; G06F 3/016; H04N 2005/443; H04N 2005/4425; G06F 3/167

(57) ABSTRACT

An electronic apparatus and a method of controlling the electronic apparatus are provided. The electronic apparatus may comprise a touch screen display, a communication interface, a sensor, a processor and a memory configured to store instructions that, when executed by the processor, cause the processor to: control the touch screen display to display a user interface for a guide to control a different electronic apparatus connected through the communication interface, obtain a detection value via the touch screen display or a sensor based on a user's input obtained using the user interface, and output first feedback based on the detection value being lower than a first threshold, second feedback based on the detection value being higher than the first threshold but lower than a second threshold, and/or third feedback based on the detection value being higher than the second threshold.

### CROSS-REFERENCE TO RELATED THE APPLICATION

This application is based on and claims the benefit of priority under 35 U.S.C. § 119 to Korean Patent Application No. 10-2018-0100454 filed on Aug. 27, 2018 in the Korean Intellectual Property Office, the disclosure of which is incorporated by reference herein in its entirety.

### BACKGROUND

### Field

The disclosure relates to a method by which an electronic apparatus controlling another electronic apparatus outputs feedback.

### Description of the Related Art

An electronic apparatus communicates with another electronic apparatuses and provides various functions. For example, the electronic apparatus may obtain and reproduce a moving image, a still image, a text or the like content reproduced in another electronic apparatuses, and may further reproduce the content with the electronic apparatus. The reproduction of the content by electronic apparatus (a first apparatus) may be simultaneous with the reproduction of the content by the another apparatus (a second apparatus).

Further, the electronic apparatus may have a remote-control function for controlling functions of other electronic apparatuses. A user may use the electronic apparatus as a remote controller to select or reproduce the content to be reproduced in other electronic apparatuses.

When a user uses the electronic apparatus as the remote controller for controlling other electronic apparatuses, it may be inconvenient to sequentially check a display of the electronic apparatus and displays of other electronic apparatuses in order to verify whether a user's input is properly transmitted to other electronic apparatuses through the electronic apparatus.

### SUMMARY

Therefore, according to various embodiments of the disclosure, a method is required to output a user feedback on whether a command corresponding to an input of the user is transmitted to other electronic apparatuses when the user employs the electronic apparatus as the remote controller.

According to an embodiment of the disclosure of the present disclosure, there is provided an electronic apparatus which may comprise: a touch screen display; a communication interface; a sensor; a processor; and a memory configured to store instructions that, when executed, cause the processor to control the touch screen display to display a user interface for a guide to control a different electronic apparatus connected via the communication interface, obtain a detection value through the touch screen display or the sensor based on a user's input obtained using the user interface, and output first feedback based on the detection value being lower than a first threshold, second feedback based on the detection value being higher than the first threshold but lower than a second threshold, and third feedback based on the detection value being higher than the second threshold.

The instructions may cause the processor to control the communication interface to transmit a command signal corresponding to the user's input to the different electronic apparatus based on the detection value being higher than the second threshold.

The instructions may cause the processor to obtain information related to content reproduced by the different electronic apparatus and output the first feedback, the second feedback, and the third feedback.

The instructions may cause the processor to obtain information about a genre of the content reproduced by the different electronic apparatus; and control the touch screen display to perform one or more functions. The one or more functions may include at least one of: output the first feedback based on a preset color corresponding to the obtained information about the genre; output the second feedback based on a color complementary to the preset color; or output the third feedback based on the preset color.

The instructions may cause the processor to output a color while changing a color output as the second feedback into a color similar to the color output as the first feedback, based on the detection value approximating the second threshold.

The electronic apparatus may further comprise an illumination sensor, and the instructions may cause the processor to output at least one among the first feedback, the second feedback, and/or the third feedback by adjusting a brightness value of the touch screen display based on brightness information obtained through the illumination sensor.

The electronic apparatus further comprises a haptic feedback module (e.g., functionality for controlling a vibrator to vibrate), and the instructions may cause the processor to obtain information about a sound volume output while the different electronic apparatus reproduces content; control the haptic feedback module (e.g., functionality for controlling a vibrator to vibrate) to perform at least one of: output vibration having preset strength corresponding to the obtained information about the sound volume, as the first feedback; output vibration having strength different from the preset strength of the vibration, as the second feedback; or output vibration having the preset strength, as the third feedback. The electronic apparatus may also comprise a vibrator.

The instructions may cause the processor to output vibration while changing the vibration output as the second feedback into vibration having similar strength to the vibration output as the first feedback, based on the detection value approximating the second threshold.

The electronic apparatus further comprises a loudspeaker, the instructions may cause the processor to obtain information about a sound and a sound volume output while the different electronic apparatus reproduces content; and control the loudspeaker to perform at least one of: output the obtained sound with a preset sound volume corresponding to the obtained sound volume, as the first feedback; output the obtained sound with a sound volume different from the preset sound volume, as the second feedback; or output the obtained sound with the preset volume, as the third feedback.

The instructions may cause the processor to output the obtained sound while changing the obtained sound output as the second feedback to have a similar sound volume to the obtained sound output as the first feedback, based on the detection value approximating the second threshold.

According to another aspect of the disclosure there is provided a method of controlling an electronic apparatus, which may comprise: displaying a user interface for a guide to control a different electronic apparatus on a touch screen display; obtain a detection value based on a user's input obtained using the user interface; and outputting first feedback based on the detection value being lower than a first threshold, second feedback based on the detection value being higher than the first threshold but lower than a second threshold, and third feedback based on the detection value being higher than the second threshold.

The method may further comprise obtaining information related to content reproduced by the different electronic apparatus and outputting the first feedback, the second feedback, and the third feedback.

The method may further comprise obtaining information about a genre of the content reproduced by the different electronic apparatus; and controlling the touch screen display to perform at least one of: outputting the first feedback based on a preset color corresponding to the obtained information about the genre; outputting the second feedback based on a color complementary to the preset color; or outputting the third feedback based on the preset color.

The method may further comprise outputting a color while changing a color output as the second feedback into a color similar to the color output as the first feedback, based on the detection value approximating the second threshold.

The electronic apparatus may further comprise an illumination sensor, and the method may further comprise outputting the feedback by adjusting a brightness value of the touch screen display based on brightness information obtained through the illumination sensor.

The electronic apparatus may further comprise a haptic feedback module (e.g., functionality for controlling a vibrator to vibrate), and the method may further comprise: obtaining information about a sound volume output while the different electronic apparatus reproduces content; and controlling the haptic feedback module to perform at least one of: outputting vibration having preset strength corresponding to the obtained information about the sound volume, as the first feedback; outputting vibration having strength different from the preset strength of the vibration, as the second feedback; or outputting vibration having the preset strength, as the third feedback. The electronic apparatus may also comprise a vibrator.

The method may further comprise outputting vibration while changing the vibration output as the second feedback into vibration having similar strength to the vibration output as the first feedback, based on the detection value approximating the second threshold.

The electronic apparatus may further comprise a loudspeaker, and the method may further comprise obtaining information about a sound and a sound volume output while the different electronic apparatus reproduces content; and controlling the loudspeaker to perform at least one of: outputting the obtained sound with a preset sound volume corresponding to the obtained sound volume, as the first feedback; outputting the obtained sound with a sound volume different from the preset sound volume, as the second feedback; or outputting the obtained sound with the preset volume, as the third feedback.

The method further may further comprise outputting the obtained sound while changing the obtained sound output as the second feedback to have a similar sound volume to the obtained sound output as the first feedback, based on the detection value approximating the second threshold.

According to another aspect of the disclosure there is provided an electronic apparatus that may comprise: a communication interface, a sensor; a plurality of input buttons; and a processor configured to perform: obtaining a detection value through (via) the sensor based on a user's input obtained along with an input of at least one button among the plurality of input buttons, and outputting first feedback based on the detection value lower than a first threshold, second feedback based on the detection value higher than the first threshold but lower than a second threshold, and third feedback based on the detection value higher than the second threshold.

### BRIEF DESCRIPTION OF THE DRAWINGS

The above and/or other aspects will become apparent and more readily appreciated from the following description of embodiments, taken in conjunction with the accompanying drawings, in which:

FIG. 1 shows diagrams illustrating a situation that an electronic apparatus according to an embodiment is used to control another electronic apparatus;

FIG. 2 is a diagram illustrating a situation that an electronic apparatus according to an embodiment uses a touch screen display to output feedback when the electronic apparatus is used to control another electronic apparatus;

FIG. 3 is a schematic diagram of an electronic apparatus according to an embodiment;

FIG. 4 is a graph illustrating a situation that an electronic apparatus according to an embodiment uses a touch screen display to output feedback;

FIG. 5 is a graph illustrating a situation that an electronic apparatus according to an embodiment and another electronic apparatus adjust screen brightness of a touch screen display which outputs feedback based on ambient brightness information;

FIG. 6 is a graph illustrating a situation that an electronic apparatus according to an embodiment adjusts screen brightness of a touch screen display which outputs feedback based on ambient brightness information;

FIG. 7 is a diagram illustrating a situation that an electronic apparatus according to an embodiment outputs feedback based on a vibration function when the electronic apparatus is used to control another electronic apparatus;

FIG. 8 is a graph illustrating a situation that an electronic apparatus according to an embodiment outputs feedback based on a vibration function;

FIG. 9 is a diagram illustrating a situation that an electronic apparatus according to an embodiment outputs feedback using a loudspeaker when the electronic apparatus is used to control another electronic apparatus;

FIG. 10 is a graph illustrating a situation that an electronic apparatus according to an embodiment outputs feedback using a loudspeaker;

FIG. 11 is a graph illustrating a situation that an electronic apparatus according to an embodiment adjusts a sound volume as feedback based on difference between a sound volume measured by the electronic apparatus according to an embodiment and a sound volume output from another electronic apparatus;

FIG. 12 is a graph illustrating a situation that an electronic apparatus according to an embodiment combines and outputs different kinds of feedback;

FIG. 13 is a flowchart illustrating a situation that an electronic apparatus according to an embodiment outputs feedback when the electronic apparatus is used to control another electronic apparatus;

FIG. 14 is a diagram illustrating an electronic apparatus according to an alternative embodiment; and

FIG. 15 is a block diagram of an electronic apparatus in a network environment according to an alternative embodiment.

### DETAILED DESCRIPTION OF EMBODIMENTS

Below, various embodiments of the disclosure will be described with reference to accompanying drawings. The following embodiments have to be considered as illustrative only, and it should be construed that all suitable modification, equivalents and/or alternatives fall within the scope of the disclosure. Throughout the drawings, like numerals refer to like elements.

In the disclosure, “have,” “may have,” “include,” “may include” or the like expression refers to presence of the corresponding features (e.g., numerical values, functions, operations, or elements of parts), and does not exclude additional features.

In the disclosure, “A or B,” “at least one of A or/and B,” “one or more of A or/and B”, “at least one of A and B”, “at least one of A or B” or the like expression(s) may involve any possible combination of listed elements. For example, “A or B,” “at least one of A and B,” or “at least one of A or B” may refer to all of (1) at least one A, (2) at least one B, or (3) both at least one A and at least one B.

In the disclosure, “a first,” “a second,” “the first,” “the second” or the like expression may modify various elements regardless of order and/or importance, and these expressions may be used to distinguish one element from a different element without limiting the elements. For example, a first user device and a second user device are irrelevant to order or importance, and may be used to express different user devices. For example, a first element may be named a second element, and vice versa without departing from the scope of the disclosure.

In addition, terms “module,” “unit,” or “part” may indicate an element that performs at least one function or operation, and such an element may be achieved by hardware, software or combination of hardware and software, and be integrated into at least one module. Further, the plurality of “modules,” “units,” “parts”, etc. may be integrated into at least one module or chip and actualized by at least one processor except that they have to be individually actualized by specific hardware.

When a certain element (e.g. a first element) is “operatively or communicatively coupled with/to” or “connected to” a different element (e.g. a second element), it will be understood that the certain element is directly coupled to the different element or coupled to the different element via a different element (e.g. a third element). On the other hand, when a certain element (e.g. the first element) is “directly coupled to” or “directly connected to” the different element (e.g. the second element), it will be understood that a different element (e.g. the third element) is not interposed between the certain element and the different element.

In the disclosure, terms may be used just for explaining a certain embodiment and not intended to limit the scope of other embodiments. A singular expression may involve a plural expression as long as it does not clearly give different meaning contextually. The terms set forth herein, including technical or scientific terms, have the same meanings as those generally understood by a person having an ordinary skill in the art. Terms defined in a general-purpose dictionary may be construed to have the same or similar meanings as the contextual meanings of the related art, and should not be interpreted as ideally or excessively formal meanings. As necessary, even the terms defined in this specification may be not construed to exclude the embodiments of the disclosure.

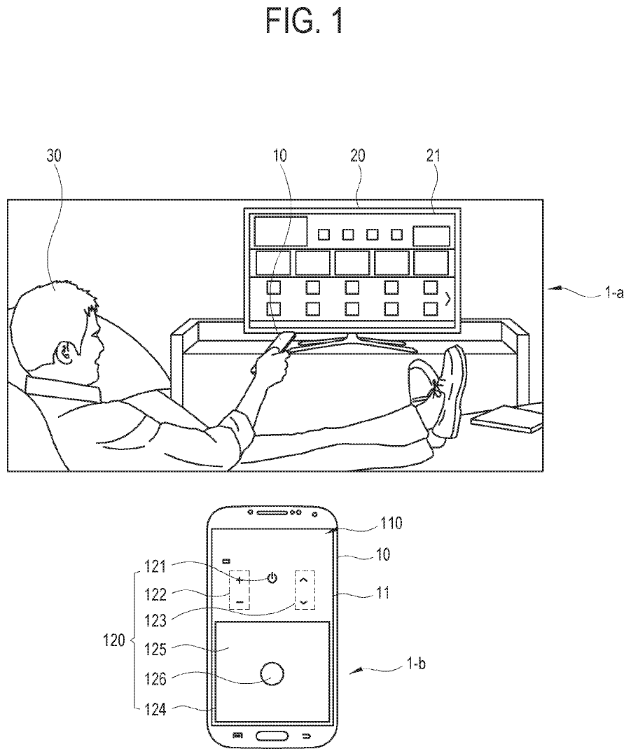

FIG. 1 shows diagrams illustrating a situation that an electronic apparatus according to an embodiment is used to control a different electronic apparatus.

Referring to the reference symbol of ‘1-a’ in FIG. 1, a user 30 may use an electronic apparatus 10 to control a different electronic apparatus 20.

According to an embodiment, the electronic apparatus 10 and the different electronic apparatus 20 may be an image display apparatus (for example, a television (TV)) capable of processing an image signal obtained from the outside and visually displaying the processed image, but not limited to this example. Alternatively, the electronic apparatus 10 and the different electronic apparatus 20 may be actualized by an apparatus that includes a memory and a processor. For example, the electronic apparatus 10 and the different electronic apparatus 20 may be actualized by various image display apparatuses such as a mobile phone, a smartphone, a tablet personal computer (PC), a digital camera, a camcorder, a laptop computer, a desktop computer, an E-book terminal, a digital broadcasting terminal, personal digital assistants (PDA), a portable multimedia player (PMP), an MP3 player, a wearable device, and the like.

According to various embodiments, the electronic apparatus 10 may include a touch screen display. The touch screen display may have a smaller screen than a screen of the different electronic apparatus 20, may be gripped by a user 30, and/or may be portable. Alternatively, the different electronic apparatus 20 may be a digital broadcast receiver capable of receiving a digital broadcast. The different electronic apparatus 20 may include a touch screen display having a larger screen than that of the electronic apparatus 10 and be stationary. The touch screen display may include a display screen that is configured to detect touch and a position of the detected touch relative to the display screen. The touch screen display device may include one or more sensors used for detecting touch.

According to an embodiment, the electronic apparatus or the different electronic apparatus 20 may provide a service necessary for a user through an app (or an application program) stored therein (e.g. an alarm app, a picture (gallery) app, a moving image play app, etc.).

According to an embodiment, the electronic apparatus and the different electronic apparatus 20 may perform communication through communication interfaces respectively included therein. The communication interfaces may be configured to perform communication between the two apparatuses. The electronic apparatus 10 and the different electronic apparatus 20 may directly perform the communication, or may perform the communication via a third apparatus (e.g. a gateway, a home server, etc.).

According to an embodiment, the electronic apparatus 10 and the different electronic apparatus 20 may establish a communication network based on a wired or wireless communication method. The electronic apparatus 10 and the different electronic apparatus 20 may each include a wireless communicator that may include a communication interface and corresponding wireless software functionality (for example, a cellular communication module, a short-range wireless communication module, or a global navigation satellite system (GNSS) communication module) or wired software functionality (for example, a local area network (LAN) communication module, or a power-line communication module). The wired and/or wireless software functionality may use a matching communication interface among them to communicate with an external electronic apparatus through a first network (for example, Bluetooth, Wi-Fi direct, infrared data association (IrDA) or the like short-range communication network) or a second network (for example, a cellular network, the Internet, a computer network (e.g. LAN or wide area network (WAN) or the like long-range communication network).

In FIG. 1, the reference symbol of ‘1-b’ illustrates one of application programs to be executed by the electronic apparatus 10.

Referring to the reference symbol of ‘1-b’ of FIG. 1, the electronic apparatus 10 may offer a user a remote-control application program 110 for controlling the different electronic apparatus 20 with which communication is established. The electronic apparatus 10 executes the remote-control application program 110 and displays a user interface 120 on a touch screen display 11 to control the different electronic apparatus 20.

According to an embodiment, the user interface 120 may include a power object 121 to power on/off the different electronic apparatus 20, a volume control object 122 to control an output volume of the different electronic apparatus, a channel changing object 123 to change a source of content to be reproduced in the different electronic apparatus 20, and an input object 124 to enable various controls for the different electronic apparatus 20.

The input object 124 may for example include a touch input region 125. The input object 124 may selectively include a touch input position 126.

According to an embodiment, a user touches the touch input position 126 with a finger and controls the different electronic apparatus 20 while moving the finger within the touch input region 125. For example, a user may select one among a plurality of items displayed on the display 11 of the different electronic apparatus 20, while moving the finger within the touch input region 125.

According to various embodiments, a user may put a finger on the touch input position 126 or a certain region of the touch input region 125, and control the different electronic apparatus 20 while moving the electronic apparatus 10. For example, the electronic apparatus 10 may include a gyro sensor, an acceleration sensor or the like sensor capable of detecting motion (for example, movement, rotation, tilting, etc.) of the electronic apparatus 10. When a user puts a finger on the touch input position 126 and then moves the electronic apparatus 10 at a predetermined speed or higher, the electronic apparatus 10 may select one among the plurality of items displayed on the different electronic apparatus 20 based on a detection value obtained by detecting the motion of the electronic apparatus through the foregoing sensor.

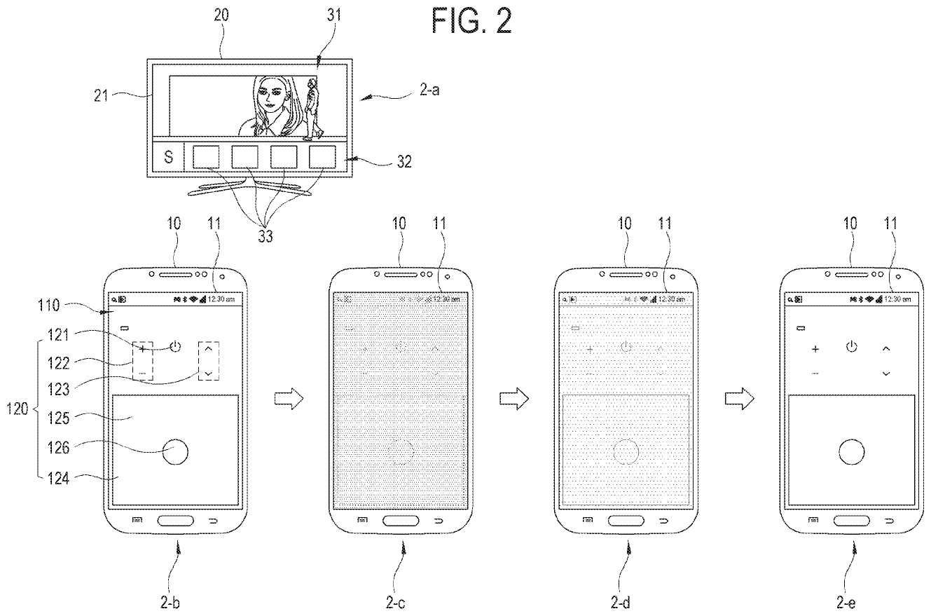

FIG. 2 is a diagram illustrating a situation that an electronic apparatus according to an embodiment uses a touch screen display to output feedback when the electronic apparatus is used to control the different electronic apparatus;

Referring to the reference symbol of ‘2-a’ of FIG. 2, the different electronic apparatus 20 may reproduce moving image content on a certain portion 31 of a display 21. The different electronic apparatus 20 may display items for controlling the different electronic apparatus 20 through another certain portion 32 of the display 21. For example, the different electronic apparatus 20 may display different pieces of content 33, which is reproducible in the different electronic apparatus 20, on another certain portion 32 of the display 21. The different electronic apparatus 20 may reproduce content selected corresponding to a user's input of selecting one among the different pieces of content 33.

In FIG. 2, the reference symbols of ‘2-b’ to ‘2-e’ illustrate the electronic apparatus 10 according to an embodiment uses the touch screen display 11 to output feedback in a situation that a user uses the electronic apparatus 10 to control the different electronic apparatus 20.

According to an embodiment, the electronic apparatus may detect various inputs of a user for controlling the different electronic apparatus 20.

For example, the electronic apparatus 10 obtains a detection value by detecting a user's touch input on the touch screen display 11, and generates and output the feedback based on the obtained detection value. Alternatively, the electronic apparatus 10 may obtain the detection value by detecting a user's input based on a motion (for example, rotation, movement, tilting, etc.) of the electronic apparatus 10, and output feedback based on the obtained detection value.

According to an embodiment, the electronic apparatus 10 may sequentially output a plurality of bunches of feedback based on the obtained detection value.

For example, the electronic apparatus 10 may output first feedback under a condition that the obtained detection value is lower than a first threshold. Further, the electronic apparatus 10 may output second feedback under a condition that the obtained detection value is lower than a first threshold and lower than a second threshold. Further, the electronic apparatus 10 may output third feedback under a condition that the obtained detection value is higher the second threshold.

Referring to the reference symbol of ‘2-b’ in FIG. 2, the electronic apparatus 10 may execute the remote-control application program 110, and display the user interface 120 on the touch screen display 11 to control the different electronic apparatus 20. A user may grip the electronic apparatus 10, and put a finger on the touch input region 124 or the touch input position 126. The electronic apparatus 10 may output the first feedback when a detection value obtained by detecting movement of a region touched by a user or a detection value obtained by detecting a movement amount of the electronic apparatus 10 moved as being gripped by a user is not higher than the first threshold.

According to an embodiment, the first feedback may be output based on content that is reproduced in the different electronic apparatus 20. For example, the first feedback may be output by expressing a preset color on the touch screen display 11 of the electronic apparatus 10 based on a genre (or a theme) of the content that is reproduced in the different electronic apparatus 20.

Specifically, when the genre of the content reproduced in the different electronic apparatus 20 corresponds to a low content rating such as a drama, a romantic comedy, and an animation for children, the electronic apparatus 10 may express a bright color having a high chroma (for example, yellow, green, etc.) on the touch screen display 11. Further, when the genre of the content reproduced in the different electronic apparatus 20 corresponds to a high content rating such as horror, a documentary, a thriller the content rating, the electronic apparatus 10 may express a dark color having a low chroma (for example, black, dark red, etc.) on the touch screen display 11.

Referring to the reference symbol of ‘2-a’ in FIG. 2, the different electronic apparatus 20 may for example be reproducing the moving image content that belongs to the genre of the romantic comedy, and the electronic apparatus 10 may obtain information about the genre of the moving image content and express bright yellow as the first feedback on the touch screen display 11.

According to various embodiments, the first feedback may be output by expressing a color having the same hue, chroma, and brightness on the touch screen display 11 of the electronic apparatus 10 as color information (e.g. hue, chroma, and brightness) of the content being reproduced in the different electronic apparatus 20. For example, the electronic apparatus 10 may output the first feedback by obtaining the color information, which is involved in one scene of content being currently displayed by the different electronic apparatus 20, from the different electronic apparatus 20. Alternatively, the electronic apparatus 10 may obtain content being reproduced by the different electronic apparatus 20 in real time, and obtain the color information included in the obtained content, thereby outputting the first feedback.

Referring to the reference symbol of ‘2-a’ in FIG. 2, the different electronic apparatus 20 may for example be displaying an image including many yellowish colors, and the electronic apparatus 10 may output the first feedback by expressing the same yellow color as that of the moving image content on the touch screen display 11.

Referring to the reference symbol of ‘2-c’ in FIG. 2, the electronic apparatus 10 may obtain a detection value generated by a user's input to the touch screen display 11 or the sensor module (not shown). For example, the electronic apparatus 10 may generate and output the second feedback when a detection value obtained by detecting movement of a region touched by a user or a detection value obtained by detecting a movement amount of the electronic apparatus 10 moved as being gripped by a user is higher than the first threshold but not higher than the second threshold.

According to an embodiment, the second feedback may be generated based on the first feedback. For example, the electronic apparatus 10 may identify and display a color, which is complementary to the color expressed as the first feedback, as the second feedback on the touch screen display 11. For example, when the electronic apparatus 10 displays a red color as the first feedback on the touch screen display 11, the electronic apparatus 10 may display a green color, which is complementary to the red color, as the second feedback on the touch screen display 11.

Referring to the reference symbol of ‘2-c’ in FIG. 2, the electronic apparatus 10 may display a purple color as the second feedback on the touch screen display 11, based on a bright yellow color displayed as the first feedback on the touch screen display 11.

According to an embodiment, the electronic apparatus 10 may continuously obtain a detection value generated by a user's input through the touch screen display 11 or the sensor module. The electronic apparatus 10 may identify change in the obtained detection value. For example, the electronic apparatus 10 may identify that the detection value approximates the second threshold. The electronic apparatus may output the second feedback varied depending on the change in the detection value. For example, the electronic apparatus 10 may sequentially change the color expressed as the second feedback into a color similar to the color expressed as the first feedback.

Referring to the reference symbol of ‘2-d’ of FIG. 2, the electronic apparatus 10 may control red (R), green (G) and blue (B) pixels of the touch screen display 11 to sequentially change the purple color displayed as the second feedback into a yellow-like color displayed as the first feedback and display the yellow-like color on the touch screen display 11 according as the obtained detection value is changed to approximate the second threshold.

According to an embodiment, the electronic apparatus 10 may continuously obtain the detection value generated by a user's input through the touch screen display 11 or the sensor module. The electronic apparatus 10 may identify change in the obtained detection value. For example, the electronic apparatus 10 may identify that the detection value is higher than the second threshold. The electronic apparatus 10 may output the third feedback when the detection value is higher than the second threshold.

According to an embodiment, the third feedback may be generated based on the first feedback. Alternatively, the third feedback may mean change of the second feedback to output the same feedback as the first feedback. For example, the electronic apparatus 10 may output the third feedback by changing the color expressed as the second feedback into the color expressed as the first feedback.

Referring to the reference symbol of ‘2-e’ in FIG. 2, the electronic apparatus 10 may change the R, G and B pixels of the touch screen display 11 to thereby quickly proceed with displaying a color similar to a yellow color, which has been displayed as the first feedback, on the display 11.

According to an embodiment, the electronic apparatus may transmit a command signal corresponding to a user's input to the different electronic apparatus 20 when the detection value is higher than the second threshold. For example, when a user moves the electronic apparatus 10 to the right and a moving speed is higher than the second threshold, the electronic apparatus 10 may transmit a command signal for selecting an item, which is right on the currently selected item, to the different electronic apparatus 20.

According to various embodiments, as described above, the electronic apparatus 10 may output the feedback based on information about content obtained from the different electronic apparatus 20. However, there are no limits to these embodiments. For example, the electronic apparatus 10 may output feedback based on information about the feedback to be output, which is obtained from the different electronic apparatus 20. Alternatively, the feedback may be output based on information about content obtained in the electronic apparatus 10 and information about the feedback (to be output) obtained from the different electronic apparatus 20.

Like this, the electronic apparatus 10 may sequentially output feedback corresponding to a user's input based on a user's input level. Thus, a user may indirectly check whether a process of using the electronic apparatus 10 to control the different electronic apparatus 20 is properly proceeding, based on change in a color displayed on the electronic apparatus 10, while keeping viewing the different electronic apparatus 20.

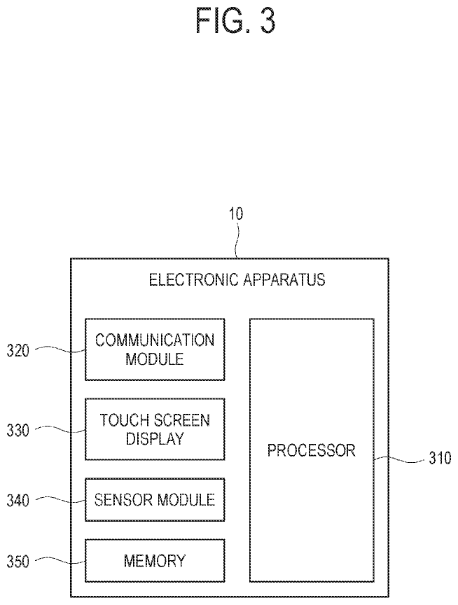

FIG. 3 is a schematic diagram of an electronic apparatus according to an embodiment.

Referring to FIG. 3, the electronic apparatus 10 may include a processor 310, a communication module 320, a touch screen display 330, a sensor module 340, and a module 350. However, there are no limits to this embodiment. For example, the electronic apparatus 10 may further include elements, or may not exclude some elements. The touch screen display 330 may include the touch screen display 11 of FIG. 1.

According to an embodiment, the processor 310 may control general operation of the electronic apparatus 10. For example, the processor 310 may obtain a detection value detected by the touch screen display 330 or the sensor module 340 and identify a user's input. The processor 310 may control the module 350 to execute a program stored in the module 350, and load or store necessary information.

According to an embodiment, the processor 310 may control the touch screen display 330 to display a user interface for guiding control of a different electronic apparatus (e.g. the different electronic apparatus 20 of FIG. 1) connected using the communication module 320, obtain a detection value through the touch screen display 330 or the sensor module 340 based on a user's input obtained using the user interface, output the first feedback when the detection value is not higher than the first threshold, output the second feedback when the detection value is higher than the first threshold but not higher than the second threshold, and output the third feedback when the detection value is higher than the second threshold.

According to an embodiment, the communication module 320 may connect the electronic apparatus 10 and the different electronic apparatus 20 under control of the processor 310. The communication module 320 may include a communication interface and one among elements for various wired or wireless communication methods, such as a wireless LAN (WLAN), Bluetooth, wired Ethernet, etc. based on performance and structures of the electronic apparatus 10.

According to an embodiment, the touch screen display 330 may display an image of executing a still image, a moving image, or an application program. The touch screen display 330 may for example detect a user's touch input and obtain a detection value. The processor 310 may output feedback based on the detection value obtained by the touch screen display 330.

According to an embodiment, the sensor module 340 may for example include a gesture sensor, a gyro sensor, an acceleration sensor, a grip sensor, etc.

According to an embodiment, the sensor module 340 may detect a motion of the electronic apparatus 10, and obtain a user's input as the detection value. The processor 310 may output feedback based on a detection value obtained by the sensor module 340.

According to an embodiment, the module 350 may include a storage medium of at least one type among a flash memory type, a hard disk type, a multimedia card micro type, a card type memory (for example, a secured digital (SD) or extreme digital (XD) memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc.

According to an embodiment, the module 350 may be configured to store instructions set for the processor to control the touch screen display 330 to display a user interface for guiding control of a different electronic apparatus 20 connected using the communication module 320, obtain a detection value through the touch screen display 330 or the sensor module 340 based on a user's input obtained using the user interface, output the first feedback when the detection value is not higher than the first threshold, output the second feedback when the detection value is higher than the first threshold but not higher than the second threshold, and output the third feedback when the detection value is higher than the second threshold.

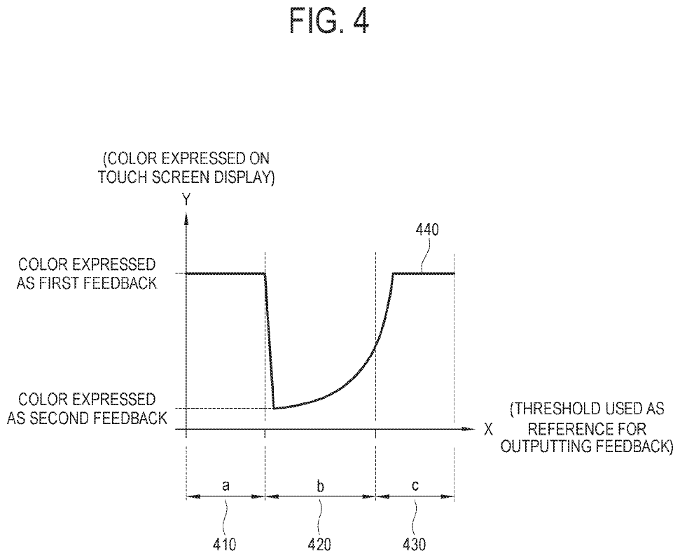

FIG. 4 is a graph illustrating a situation that an electronic apparatus according to an embodiment uses a touch screen display to output feedback;

Referring to FIG. 4, the X-axis in the graph indicates thresholds used as references in outputting various kinds of feedback. The Y-axis indicates colors expressed on the touch screen display (e.g. the touch screen display 11 of FIG. 1) included in the electronic apparatus 10.

According to an embodiment, a section ‘a’ 410 may indicate a section where the detection value is in between ‘0’ and the first threshold, a section ‘b’ 420 may indicate a section where the detection value is in between the first threshold and the second threshold, and a section ‘c’ 430 may indicate a section where the detection value is higher than the second threshold. As described above with reference to FIG. 2, the detection value may be a value obtained as a result of detecting a user's input for controlling another electronic apparatus (e.g. the different electronic apparatus 20 of FIG. 1).

According to an embodiment, a line 440 shown in the graph may indicate change in color expressed as the first feedback, the second feedback, and the third feedback by the electronic apparatus 10.

Referring to FIG. 4, the electronic apparatus 10 may identify that the detection value is in the section ‘a’ 410. For example, in a situation that the electronic apparatus 10 executes a remote-control application program and displays a user interface for controlling the different electronic apparatus 20 on the touch screen display, the detection value obtained from a user's input by the electronic apparatus 10 may be in the section ‘a’ 410.

Alternatively, in a situation the user interface for controlling the different electronic apparatus 20 is displayed on the touch screen display 11, a user may grip the electronic apparatus 10 and then put a finger on the touch input region (e.g. the touch input region 125 of FIG. 1) or the touch input position (e.g. the touch input position 126 of FIG. 1).

According to an embodiment, the electronic apparatus 10 may output the first feedback when it is identified that the detection value is in the section ‘a’ 410.

The first feedback may for example mean that the electronic apparatus 10 displays the same or similar color to a color related to content reproduced in the different electronic apparatus 20 on the touch screen display 11.

The color related to the content may for example mean a preset color according to the genres of the content. Alternatively, the color related to the content may mean a color involved in one scene of the content displayed on the display of the different electronic apparatus 20 by the different electronic apparatus 20.

Referring to FIG. 4, the electronic apparatus 10 may identify that the detection value enters the section ‘b’ 420. For example, the electronic apparatus 10 may detect that a user puts a finger on the touch input region 125 or the touch input position 126 displayed on the touch screen display 11 and moves the electronic apparatus 10. The electronic apparatus 10 may obtain the detected value as the detection value, and identify that the obtained detection value enters the section ‘b’ 420.

Alternatively, the electronic apparatus 10 may detect that a user puts and drags a finger on the touch input region 125 or the touch input position 126 displayed on the touch screen display 11. The electronic apparatus 10 may obtain the detected value as the detection value and identify that the obtained detection value enters the section ‘b’ 420.

According to an embodiment, the electronic apparatus 10 may output the second feedback when it is identified that the detection value is in the section ‘b’ 420.

The second feedback may for example be generated based on the first feedback. For example, the electronic apparatus 10 may identify and display a color, which is complementary to the color expressed as the first feedback, as the second feedback on the touch screen display 11. For example, when the electronic apparatus 10 displays a red color as the first feedback on the touch screen display 11, the electronic apparatus 10 may display a green color, which is complementary to the red color, as the second feedback on the touch screen display 11.

According to an embodiment, the electronic apparatus may identify that the detection value gradually approximates the second threshold in the section ‘b’ 420. The electronic apparatus 10 may output the second feedback varied depending on the change in the detection value. For example, the electronic apparatus 10 may sequentially change the color expressed as the second feedback into a color similar to the color expressed as the first feedback. In other words, the electronic apparatus 10 may output the second feedback to gradually change to have the same color as the color of the first feedback onto the touch screen display 11 according as the detection value is changed from the first threshold to the second threshold.

Referring to FIG. 4, the electronic apparatus 10 may identify that the detection value enters the section ‘c’ 430. For example, the electronic apparatus 10 may detect that a user moves the electronic apparatus 10 at a preset speed or higher. The electronic apparatus 10 may obtain a detection value based on a detected value, and identify that the obtained detection value enters the section ‘c’ 430.

Alternatively, the electronic apparatus 10 may detect that a user's touch & drag input moves beyond a preset distance. The electronic apparatus 10 may obtain a detected value as a detection value, and identify that the obtained detection value enters the section ‘c’ 430.

According to an embodiment, the electronic apparatus 10 may output the third feedback when it is identified that the detection value is in the section ‘c’ 430.

The third feedback may for example mean change of the second feedback to output the same feedback as the first feedback. For example, when the detection value is higher than the second threshold in the situation where the second feedback has been displayed, the electronic apparatus 10 may change the color that has been expressed as the second feedback into the color expressed as the first feedback, and eventually display the color that has been expressed as the first feedback.

Like this, the electronic apparatus 10 may sequentially output feedback corresponding to a user's input based on a user's input level. Thus, a user may indirectly check whether a process of using the electronic apparatus 10 to control the different electronic apparatus 20 is properly proceeding, based on change in a color displayed on the electronic apparatus 10, while keeping viewing the different electronic apparatus 20.

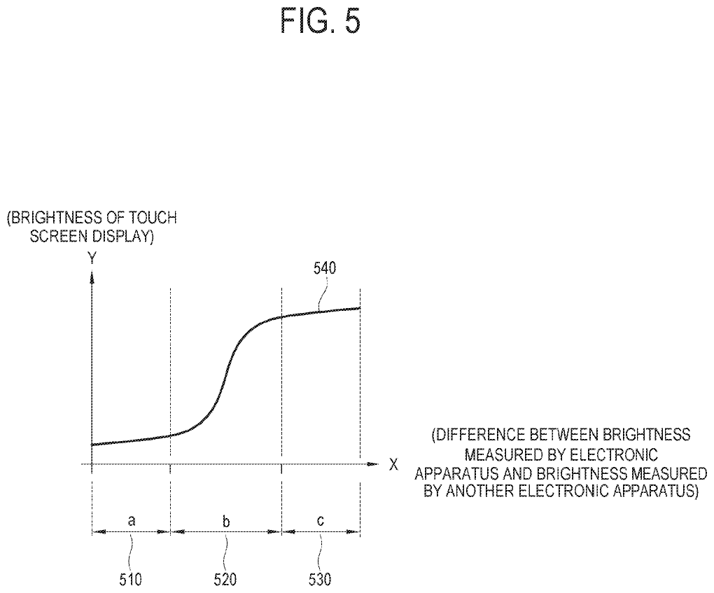

FIG. 5 is a graph illustrating a situation that an electronic apparatus according to an embodiment and the different electronic apparatus adjust screen brightness of a touch screen display which outputs feedback based on ambient brightness information.

Referring to FIG. 5, the X-axis in the graph indicates a difference between a value measured using an illumination sensor included in another electronic apparatus (e.g. the different electronic apparatus 20 of FIG. 1) and a value measured using an illumination sensor included in the electronic apparatus 10. The Y-axis indicates brightness of the touch screen display (e.g. the touch screen display 11 of FIG. 1) included in the electronic apparatus 10.

According to an embodiment, the electronic apparatus 10 may adjust the brightness of the touch screen display 11 based on information about the ambient brightness of the electronic apparatus 10 and the different electronic apparatus 20 when the feedback is output by displaying a color on the touch screen display 11.

According to an embodiment, a line 540 in the graph may mean change in brightness of the touch screen display 11 included in the electronic apparatus 10 when information about the ambient brightness of the electronic apparatus 10 and the different electronic apparatus 20 is taken into account.

According to an embodiment, a section ‘a’ 510 may show a case that a value measured using the illumination sensor included in the electronic apparatus 10 is higher by more than a preset value than a value measured using the illumination sensor included in the different electronic apparatus 20. In other words, the surroundings around the electronic apparatus 10 may be brighter than the surroundings around the different electronic apparatus 20.

In this case, the electronic apparatus 10 may adjust the brightness of the touch screen display 11 to be darker than the brightness of the display (e.g. the display 21 of FIG. 1) included in the different electronic apparatus 20.

According to an embodiment, a section ‘b’ 520 may show a case that a difference between a value measured using the illumination sensor included in the electronic apparatus 10 and a value measured using the illumination sensor included in the different electronic apparatus 20 is within a preset range. In other words, the ambient brightness of the electronic apparatus 10 may be similar to the ambient brightness of the different electronic apparatus 20.

In this case, the electronic apparatus 10 may adjust the brightness of the touch screen display 11 based on the brightness of the display 21 included in the different electronic apparatus 20. In other words, when a brightness level of the display 21 included in the different electronic apparatus 20 becomes higher or lower, the electronic apparatus 10 also control the brightness of the touch screen display 11 to make its brightness level higher or lower.

According to an embodiment, a section ‘c’ 530 may show a case where a value measured using the illumination sensor included in the electronic apparatus 10 is lower by more than a preset value than a value measured using the illumination sensor included in the different electronic apparatus 20. In other words, the surroundings around the electronic apparatus 10 may be darker than the surroundings around the different electronic apparatus 20.

In this case, the electronic apparatus 10 may adjust the brightness of the touch screen display 11 to be brighter than the brightness of the display 21 included in the different electronic apparatus 20.

Like this, according to an embodiment of the disclosure, the electronic apparatus 10 may output a user feedback suitable for a situation by adjusting the brightness of the touch screen display 11 based on information about ambient brightness of the electronic apparatus 10 and the different electronic apparatus 20 when the feedback is output through the touch screen display 11.

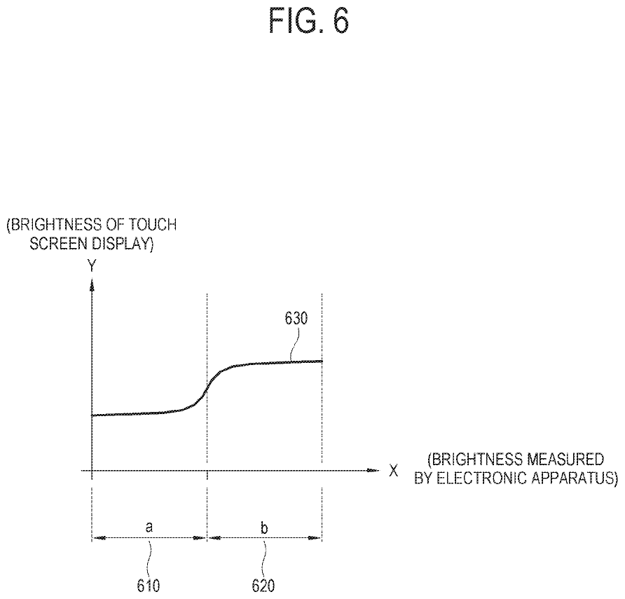

FIG. 6 is a graph illustrating a situation that an electronic apparatus according to an embodiment adjusts screen brightness of a touch screen display which outputs feedback based on ambient brightness information.

Referring to FIG. 6, the X-axis in the graph indicates a brightness value measured using the illumination sensor included in the electronic apparatus 10. The Y-axis indicates the brightness of the touch screen display 11 included in the electronic apparatus 10.

According to an embodiment, the electronic apparatus 10 may adjust the brightness of the touch screen display 11 based on the ambient brightness information of the electronic apparatus 10 when the feedback is output with a color displayed on the touch screen display 11.

According to an embodiment, a line 630 in the graph may mean change in the brightness of the touch screen display included in the electronic apparatus 10 by taking the ambient brightness information of the electronic apparatus 10 into account.

According to an embodiment, a section ‘a’ 610 may show a case that a value measured by the illumination sensor of the electronic apparatus 10 is lower than a brightness value of the touch screen display 11 included in the electronic apparatus 10. In other words, the surroundings around the electronic apparatus 10 may be darker than the brightness of the touch screen display 11 included in the electronic apparatus 10.

In this case, the electronic apparatus 10 may adjust the brightness of the touch screen display 11 to decrease corresponding to ambient brightness.

According to an embodiment, a section ‘b’ 620 may show a case that a value measured by the illumination sensor of the electronic apparatus 10 is higher than the brightness value of the touch screen display 11 included in the electronic apparatus 10. In other words, the surroundings around the electronic apparatus 10 may be brighter than the brightness of the touch screen display 11 included in the electronic apparatus 10.

In this case, the electronic apparatus 10 may adjust the brightness of the touch screen display 11 to increase corresponding to the ambient brightness.

Like this, according to an embodiment of the disclosure, the electronic apparatus 10 may adjust the brightness of the touch screen display 11 based on the ambient brightness of the electronic apparatus 10 and output feedback suitable for a situation to a user in a case where there are no information about the ambient brightness of the different electronic apparatus 20 when the feedback is output through the touch screen display 11.

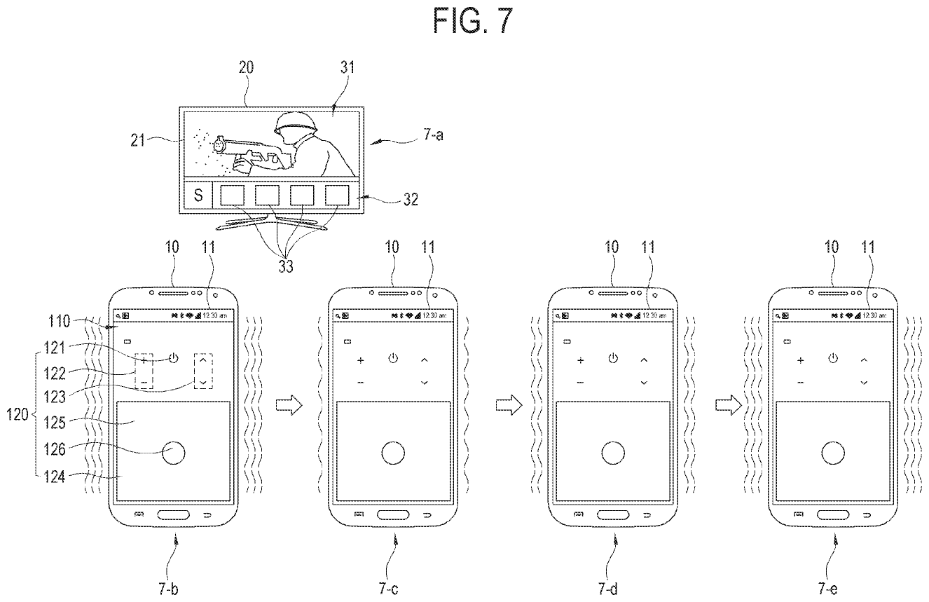

FIG. 7 is a diagram illustrating a situation that an electronic apparatus according to an embodiment outputs feedback based on a vibration function when the electronic apparatus is used to control the different electronic apparatus.

Referring to the reference symbol of ‘7-a’ in FIG. 7, the different electronic apparatus 20 may reproduce moving image content on a certain portion 31 of the display 21. The different electronic apparatus 20 may use another certain portion 32 of the display 21 to display items for controlling the different electronic apparatus 20. For example, the different electronic apparatus 20 may display different pieces of content 33 reproducible by the different electronic apparatus 20 on a different certain portion 32 of the display 21. In response to a user's input for selecting one among different pieces of content 33, the different electronic apparatus 20 may reproduce the selected content.

In FIG. 7, the reference symbols of ‘7-b’ to ‘7-e’ illustrate that the electronic apparatus 10 uses a vibration function to output feedback in a situation that a user uses the electronic apparatus 10 according to an embodiment to control the different electronic apparatus 20.

According to an embodiment, the electronic apparatus may detect various user's inputs for controlling the different electronic apparatus 20.

For example, the electronic apparatus 10 may obtain a detection value by detecting a user's touch input on the touch screen display 11, and generate and output feedback based on the obtained detection value. Alternatively, the electronic apparatus 10 obtains a detection value by detecting a user's input based on a motion (for example, rotation, movement, tilting, etc.) of the electronic apparatus 10, and output feedback based on the obtained detection value.

According to an embodiment, the electronic apparatus 10 may sequentially output a plurality of bunches of feedback based on an obtained detection value.

For example, the electronic apparatus 10 may output the first feedback under a condition that the obtained detection value is lower than the first threshold. Further, the electronic apparatus 10 may output the second feedback under a condition that the obtained detection value is higher than the first threshold but lower than the second threshold. Further, the electronic apparatus 10 may output the third feedback under a condition that the obtained detection value is higher the second threshold.

Referring to the reference symbol of ‘7-b’ in FIG. 7, the electronic apparatus 10 may execute the remote-control application program 110, and display the user interface 120 for controlling the different electronic apparatus 20 on the touch screen display 11. A user may grip the electronic apparatus 10, and put a finger on the touch input region 125 or the touch input position 126. The electronic apparatus 10 may output the first feedback when a detection value obtained by detecting movement of a region touched by a user or a detection value obtained by detecting a movement amount of the electronic apparatus 10 moved as being gripped by a user is not higher than the first threshold.

According to an embodiment, the first feedback may be generated based on content that is reproduced in the different electronic apparatus 20. For example, the first feedback may make vibration of a preset level in the electronic apparatus 10 based on a sound of content that is reproduced in the different electronic apparatus 20.

According to an embodiment, the electronic apparatus may obtain information about a sound output from the different electronic apparatus 20. For example, the electronic apparatus 10 may obtain information about a sound volume output from the different electronic apparatus 20. The electronic apparatus 10 may identify strength of vibration to be output as the first feedback corresponding to a obtained sound volume. In other words, the electronic apparatus 10 may output strong vibration when a obtained sound volume is high, but may output weak vibration when a obtained sound volume is low.

Referring to the reference symbol of ‘7-a’ in FIG. 7, the different electronic apparatus 20 is reproducing the moving image content. The electronic apparatus 10 may obtain information about a sound volume corresponding to reproduction of the moving image content. The electronic apparatus 10 may make vibration by controlling a haptic module or the like based on the obtained sound volume. For example, when the obtained sound volume is higher than 70 dB, the electronic apparatus 10 may make the maximum vibration. However, the strength of the vibration based on the obtained sound volume is not limited to this example. The electronic apparatus 10 may provide a user interface, through which the strength of the vibration is set corresponding to the obtained sound volume, to a user.

Referring to the reference symbol of ‘7-c’ in FIG. 7, the electronic apparatus 10 may obtain a detection value generated based on a user's input through the touch screen display 11 or the sensor module (not shown). For example, the electronic apparatus 10 may generate and output the second feedback when a detection value obtained by detecting movement of a region touched by a user or a detection value obtained by detecting a movement amount of the electronic apparatus 10 moved as being gripped by a user is higher than the first threshold but not higher than the second threshold.

According to an embodiment, the second feedback may be generated based on the first feedback. For example, the electronic apparatus 10 may make the minimum strength of vibration as the second feedback when the maximum strength of vibration is made as the first feedback.

According to an embodiment, the electronic apparatus 10 may continuously obtain the detection value generated based on a user's input to the touch screen display 11 or the sensor module. The electronic apparatus 10 may identify change in the obtained detection value.

Referring to the reference symbol of ‘7-d’ in FIG. 7, the electronic apparatus 10 may identify that the detection value is changed into a value approximating the second threshold. The electronic apparatus 10 may output the second feedback varied depending on change in the detection value. For example, the electronic apparatus 10 may gradually change the vibration become stronger. In other words, when the detection value is changed into a value approximating the second threshold, the electronic apparatus 10 may gradually change the vibration stronger corresponding to the changed value.

According to an embodiment, the electronic apparatus 10 may continuously obtain the detection value generated based on a user's input through the touch screen display 11 or the sensor module. The electronic apparatus 10 may identify the change in the obtained detection value. For example, the electronic apparatus 10 may identify that the detection value is higher than the second threshold. The electronic apparatus 10 may output the third feedback when the detection value is higher than the second threshold.

According to an embodiment, the third feedback may be generated based on the first feedback. Alternatively, the third feedback may mean that the second feedback is changed to output the same feedback as the first feedback.

Referring to the reference symbol of ‘7-e’ in FIG. 7, the electronic apparatus 10 may change the strength of the vibration output as the second feedback into the strength of the vibration output as the first feedback, thereby outputting the third feedback.

According to various embodiments, the electronic apparatus 10 may distinguish among the first feedback, the second feedback, and the third feedback based on the kind of vibration. For example, when the obtained sound is higher than 70 dB, the electronic apparatus 10 may output vibration having the highest frequency as the first feedback.

According to various embodiments, the electronic apparatus 10 may output vibration having the lowest frequency as the second feedback. The electronic apparatus 10 may gradually change the vibration to have a higher frequency when the detection value is changed into a value approximating the second threshold.

According to various embodiments, the electronic apparatus 10 may make vibration having the highest frequency as the third feedback like the first feedback.

According to various embodiments, the electronic apparatus 10 may give notice to a user when a user's input to the different electronic apparatus 20 is not valid. For example, when a user's input is made with regard to an item that is not present any more, the electronic apparatus 10 may give notice to a user by making vibration different in frequency or strength from the vibration that has been made.

Like this, the electronic apparatus 10 may sequentially output feedback corresponding to a user's input based on a user's input level. Thus, a user may indirectly check whether a process of using the electronic apparatus 10 to control the different electronic apparatus 20 is properly proceeding, based on change in vibration made by the electronic apparatus 10, while keeping viewing the different electronic apparatus 20.

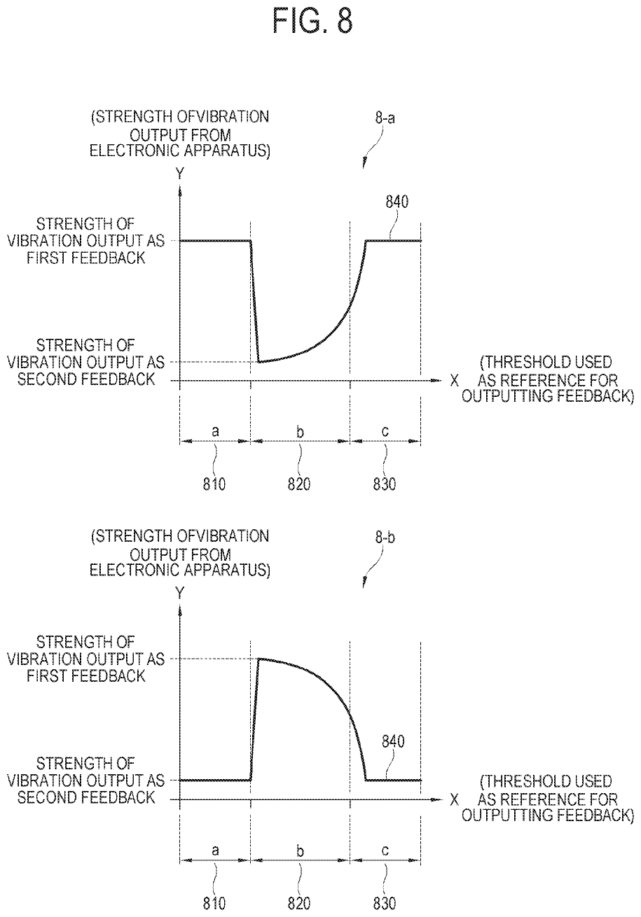

FIG. 8 is a graph illustrating a situation that an electronic apparatus according to an embodiment outputs feedback based on a vibration function.

Referring to FIG. 8, the X-axis in the graph indicates a threshold used as a reference for outputting various kinds of feedback. The Y-axis indicates strength of vibration made by the electronic apparatus 10.

According to an embodiment, a section ‘a’ 810 may indicate a section where the detection value is in between ‘0’ and the first threshold, a section ‘b’ 820 may indicate a section where the detection value is in between the first threshold and the second threshold, and a section ‘c’ 830 may indicate a section where the detection value is higher than the second threshold. As described above with reference to FIG. 2, the detection value may be a value obtained as a result of detecting a user's input for controlling another electronic apparatus (e.g. the different electronic apparatus 20 of FIG. 7).

According to an embodiment, a line 840 shown in the graph may indicate change in strength of vibration output as the first feedback, the second feedback, and the third feedback by the electronic apparatus 10.

Referring to the reference symbol of ‘8-a’ in FIG. 8, the electronic apparatus 10 may identify that the detection value is in the section ‘a’ 810. For example, in a situation that the electronic apparatus 10 executes the remote-control application program (e.g. the remote-control application program 110 of FIG. 7) and displays a user interface (e.g. the user interface 120 of FIG. 7) for controlling the different electronic apparatus 20 on the touch screen display (e.g. the touch screen display 11 of FIG. 7), the detection value obtained based on a user's input by the electronic apparatus may be in the section ‘a’ 810. Alternatively, in a situation that the user interface 120 for controlling the different electronic apparatus 20 is displayed on the touch screen display 11, a user may grip the electronic apparatus 10 and then put a finger on the touch input region (e.g. the touch input region 125 of FIG. 7) or the touch input position (e.g. the touch input position 126 of FIG. 7).

According to an embodiment, the electronic apparatus 10 may output the first feedback when it is identified that the detection value is in the section ‘a’ 810.

The first feedback may for example make vibration of a preset level by the electronic apparatus 10 based on a sound of content reproduced in the different electronic apparatus 20. The electronic apparatus 10 may control the haptic module based on the obtained sound volume, thereby outputting the vibration. For example, when the obtained sound volume is higher than 70 dB, the electronic apparatus 10 may output the maximum vibration.

Referring to the reference symbol of ‘8-a’ in FIG. 8, the electronic apparatus 10 may identify that the detection value enters the section ‘b’ 820. For example, the electronic apparatus 10 may detect that a user puts a finger on the touch input region 125 or the touch input position 126 displayed on the touch screen display 11 and moves the electronic apparatus 10. The electronic apparatus 10 may obtain the detection value based on the detected value, and identify that the obtained detection value enters the section ‘b’ 820. Alternatively, the electronic apparatus 10 may detect that a user puts a finger on the touch input region 125 or the touch input position 126 displayed on the touch screen display 11 and drags the finger. The electronic apparatus 10 may obtain the detection value based on the detected value and identify that the obtained detection value enters the section ‘b’ 820.

According to an embodiment, the electronic apparatus 10 may output the second feedback when it is identified that the detection value is in the section ‘b’ 820.

The second feedback may for example be output based on the first feedback. For example, the electronic apparatus may output the minimum vibration as the second feedback when the maximum vibration is output as the first feedback.

According to an embodiment, the electronic apparatus may identify that the detection value gradually approximates the second threshold in the section ‘b’ 820. The electronic apparatus 10 may output the second feedback varied depending on change in the detection value. For example, the electronic apparatus 10 may change the vibration to become stronger. In other words, the electronic apparatus 10 may gradually increase the strength of the vibration to be output according as the detection value is changed into a value approximating the second threshold.

Referring to the reference symbol of ‘8-a’ in FIG. 8, the electronic apparatus 10 may output the third feedback when it is identified that the detection value is in the section ‘c’ 830.

The third feedback may for example mean change of the second feedback to thereby output the same feedback as the first feedback. For example, the electronic apparatus 10 may output the third feedback by changing the strength of vibration output as the second feedback into the strength of vibration output as the first feedback.

The reference symbol of ‘8-b’ in FIG. 8 is the graph illustrating a situation that the electronic apparatus according to various embodiments uses the vibration function to output the feedback.

Referring to the reference symbol of ‘8-b’ in FIG. 8, the electronic apparatus 10 may identify that the detection value is in the section ‘a’ 810.

According to an embodiment, the electronic apparatus 10 may output the first feedback when the detection value is in the section ‘a’ 810. The first feedback may for example make vibration of a preset level by the electronic apparatus based on a sound of content reproduced in the different electronic apparatus 20. The electronic apparatus 10 may control the haptic module based on the obtained sound volume, thereby making the vibration. For example, when the obtained sound volume is not higher than 40 dB, the electronic apparatus 10 may make the minimum vibration.

Referring to the reference symbol of ‘8-b’ in FIG. 8, the electronic apparatus 10 may identify that the detection value enters the section ‘b’ 820. According to an embodiment, the electronic apparatus 10 may output the second feedback when it is identified that the detection value is in the section ‘b’ 820.

The second feedback may for example be generated based on the first feedback. For example, the electronic apparatus 10 may output the maximum vibration as the second feedback when the minimum vibration is output as the first feedback.

According to an embodiment, the electronic apparatus may identify that the detection value gradually approximates the second threshold in the section ‘b’ 820. The electronic apparatus 10 may output the second feedback varied depending on change in the detection value. For example, the electronic apparatus 10 may change the vibration to become weaker. In other words, the electronic apparatus 10 may gradually decrease the strength of the vibration output according as the detection value is changed into a value approximating the second threshold.

Referring to the reference symbol of ‘8-b’ in FIG. 8, the electronic apparatus 10 may output the third feedback when it is identified that the detection value is in the section ‘c’ 830.

The third feedback may for example mean change of the second feedback to output the same feedback as the first feedback. For example, the electronic apparatus 10 may output the third feedback by changing the strength of the vibration output as the second feedback into the strength of the vibration output as the first feedback.

Like this, the electronic apparatus 10 may sequentially output feedback corresponding to a user's input based on a user's input level. Thus, a user may indirectly check whether a process of using the electronic apparatus 10 to control the different electronic apparatus 20 is properly proceeding, based on change in the vibration made by the electronic apparatus 10, while keeping viewing the different electronic apparatus 20.

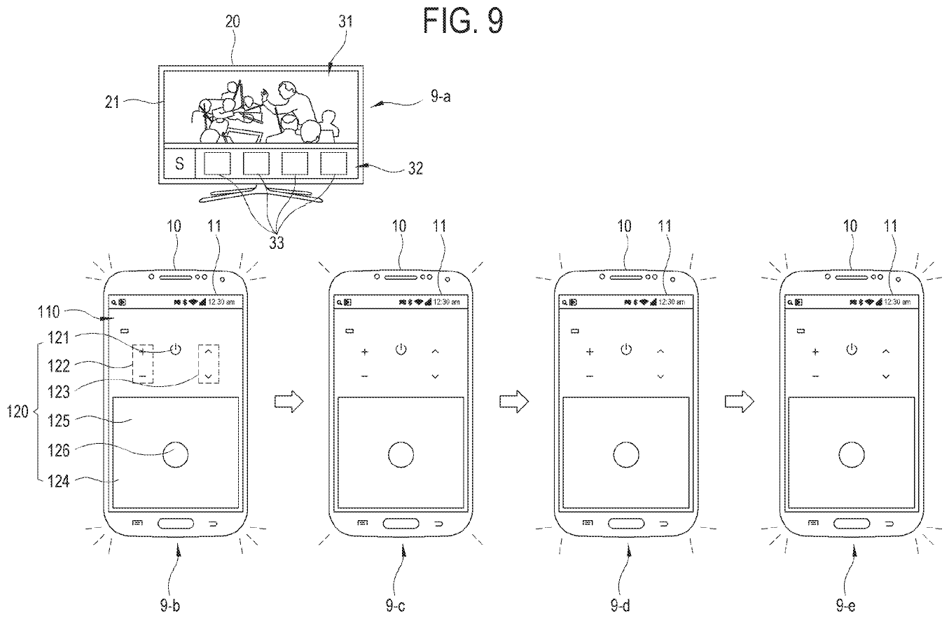

FIG. 9 is a diagram illustrating a situation that an electronic apparatus according to an embodiment outputs feedback using a loudspeaker when the electronic apparatus is used to control the different electronic apparatus.

Referring to the reference symbol of ‘9-a’ in FIG. 9, the different electronic apparatus 20 may reproduce moving image content on a certain portion 31 of the display 21. The different electronic apparatus 20 may display items for controlling the different electronic apparatus 20 through another certain portion 32 of the display 21. For example, the different electronic apparatus 20 may display different pieces of content 33, which is reproducible in the different electronic apparatus 20, on another certain portion 32 of the display 21. The different electronic apparatus 20 may reproduce content selected corresponding to a user's input of selecting one among the different pieces of content 33.

In FIG. 9, the reference symbols of ‘9-b’ to ‘9-e’ illustrate that the electronic apparatus 10 according to an embodiment uses the loudspeaker to output feedback in a situation that a user uses the electronic apparatus 10 to control the different electronic apparatus 20.

According to an embodiment, the electronic apparatus may detect various inputs of a user for controlling the different electronic apparatus 20. For example, the electronic apparatus 10 may obtain a detection value by detecting a user's touch input on the touch screen display 11, and output the feedback based on the obtained detection value.

According to an embodiment, the electronic apparatus 10 may sequentially output a plurality of bunches of feedback based on the obtained detection value.

For example, the electronic apparatus 10 may output the first feedback under a condition that the obtained detection value is lower than the first threshold. Further, the electronic apparatus 10 may output the second feedback under a condition that the obtained detection value is higher than the first threshold but lower than the second threshold. Further, the electronic apparatus 10 may output the third feedback under a condition that the obtained detection value is higher the second threshold.

Referring to the reference symbol of ‘9-b’ in FIG. 9, the electronic apparatus 10 may execute the remote-control application program 110, and display the user interface 120 on the touch screen display 11 to control the different electronic apparatus 20. A user may grip the electronic apparatus 10 and put a finger on the touch input region 125 or the touch input position 126. The electronic apparatus 10 may output the first feedback when a detection value obtained by detecting movement of a region touched by a user or a detection value obtained by detecting a movement amount of the electronic apparatus 10 moved as being gripped by a user is not higher than the first threshold.

According to an embodiment, the first feedback may be output based on content that is reproduced in the different electronic apparatus 20. For example, the first feedback may be output by a sound output from the electronic apparatus 10 based on the sound of the content reproduced in the different electronic apparatus 20.

According to an embodiment, the electronic apparatus may obtain information about a sound output from the different electronic apparatus 20. For example, the electronic apparatus 10 may obtain a sound output from the different electronic apparatus 20 in real time. Further, the electronic apparatus 10 may obtain information about a sound volume output from the different electronic apparatus 20. The electronic apparatus 10 may output a obtained sound corresponding to the obtained sound volume as the first feedback. In other words, the electronic apparatus 10 may turn the obtained sound volume up in real time when the obtained sound is big, and turn the obtained sound volume down in real time when the obtained sound is small.

Referring to the reference symbol of ‘9-a’ in FIG. 9, the different electronic apparatus 20 is reproducing the moving image content. The electronic apparatus 10 may obtain a sound, which is made while reproducing the moving image content, in real time. Further, the electronic apparatus 10 may obtain information about a sound volume reproduced by the different electronic apparatus 20. The electronic apparatus may output a obtained sound based on the obtained sound volume. For example, when the obtained sound volume is higher than 70 dB, the electronic apparatus 10 may output the obtained sound with the maximum sound volume. However, the sound volume output based on the obtained sound volume is not limited to this example. The electronic apparatus 10 may provide a user interface, through which the output sound volume is set corresponding to the obtained sound volume, to a user.

Referring to the reference symbol of ‘9-c’ in FIG. 9, the electronic apparatus 10 may obtain a detection value generated based on a user's input through the touch screen display 11 or the sensor module (not shown). For example, the electronic apparatus 10 may generate and output the second feedback when a detection value obtained by detecting movement of a region touched by a user or a detection value obtained by detecting a movement amount of the electronic apparatus 10 moved as being gripped by a user is higher than the first threshold but not higher than the second threshold.

According to an embodiment, the second feedback may be generated based on the first feedback. For example, the electronic apparatus 10 may output a sound with the minimum volume as the second feedback when a sound with the maximum volume is output as the first feedback.

According to an embodiment, the electronic apparatus 10 may continuously obtain the detection value generated based on a user's input to the touch screen display 11 or the sensor module. The electronic apparatus 10 may identify change in the obtained detection value.

Referring to the reference symbol of ‘9-d’ in FIG. 9, the electronic apparatus 10 may identify that the detection value is changed into a value approximating the second threshold. The electronic apparatus 10 may output the second feedback varied depending on change in the detection value. For example, the electronic apparatus 10 may gradually turn the sound volume up. In other words, when the detection value is changed into a value approximating the second threshold, the electronic apparatus 10 may gradually increase the sound volume corresponding to the changed value.

According to an embodiment, the electronic apparatus 10 may continuously obtain the detection value generated based on a user's input through the touch screen display 11 or the sensor module. The electronic apparatus 10 may identify the change in the obtained detection value. For example, the electronic apparatus 10 may identify that the detection value is higher than the second threshold. The electronic apparatus 10 may output the third feedback when the detection value is higher than the second threshold.

According to an embodiment, the third feedback may be generated based on the first feedback. Alternatively, the third feedback may mean that the second feedback is changed to output the same feedback as the first feedback.

Referring to the reference symbol of ‘9-e’ in FIG. 9, the electronic apparatus 10 may change the sound volume output as the second feedback into the sound volume output as the first feedback, thereby outputting the third feedback.

According to various embodiments, the electronic apparatus 10 may give notice to a user when a user's input to the different electronic apparatus 20 is not valid. For example, when a user's input is made with regard to an item that is not present any more, the electronic apparatus 10 may give notice to a user by providing a noise effect or the like instead of the sound obtained and output in real time.

According to various embodiments, the electronic apparatus 10 may output a directional sound corresponding to a direction of a user's input. For example, when the electronic apparatus 10 includes a plurality of loudspeakers, the loudspeaker positioned corresponding to a direction of a user's input is configured to make an output, thereby outputting three-dimensional feedback to the user.

Like this, the electronic apparatus 10 may sequentially output feedback corresponding to a user's input based on a user's input level. Thus, a user may indirectly check whether a process of using the electronic apparatus 10 to control the different electronic apparatus 20 is properly proceeding, based on change in a sound output from the electronic apparatus 10, while keeping viewing the different electronic apparatus 20.

Further, the electronic apparatus 10 outputs the same sound as the sound being output from the different electronic apparatus 20, thereby outputting a stereophonic sound effect to a user.

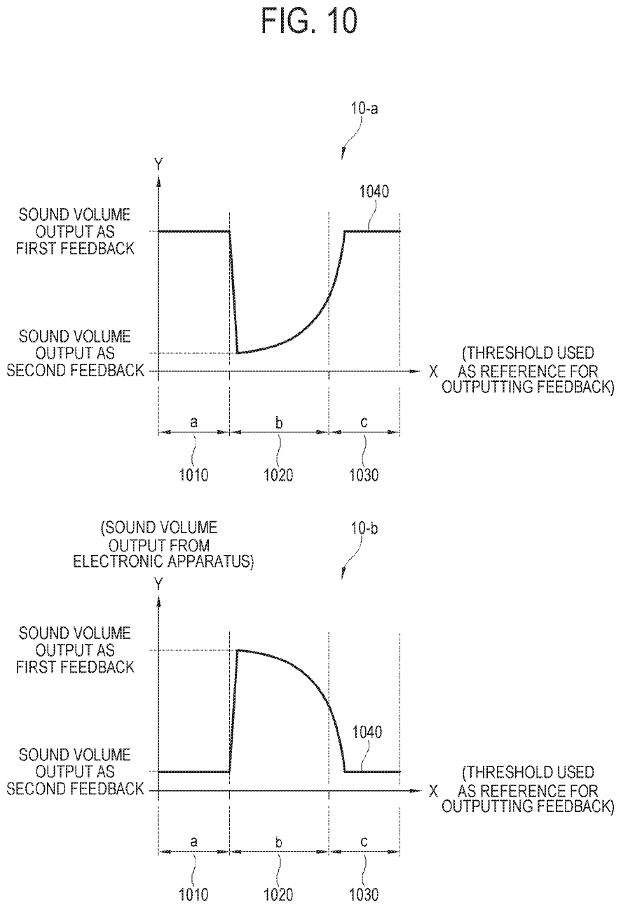

FIG. 10 is a graph illustrating a situation that an electronic apparatus according to an embodiment outputs feedback using a loudspeaker.

Referring to FIG. 10, the X-axis in the graph indicates a threshold used as a reference for outputting various kinds of feedback. The Y-axis indicates a sound volume output from the electronic apparatus 10.

According to an embodiment, a section ‘a’ 1010 may indicate a section where the detection value is in between ‘0’ and the first threshold, a section ‘b’ 1020 may indicate a section where the detection value is in between the first threshold and the second threshold, and a section ‘c’ 1030 may indicate a section where the detection value is higher than the second threshold. As described above with reference to FIG. 2, the detection value may be a value obtained as a result of detecting a user's input for controlling another electronic apparatus (e.g. the different electronic apparatus 20 of FIG. 9).

According to an embodiment, a line 1040 shown in the graph may indicate change in sound volume output as the first feedback, the second feedback, and the third feedback by the electronic apparatus 10.

Referring to the reference symbol of ‘10-a’ in FIG. 10, the electronic apparatus 10 may identify that the detection value is in the section ‘a’ 1010. For example, in a situation that the electronic apparatus 10 executes the remote-control application program (e.g. the remote-control application program 110 of FIG. 9) and displays a user interface (e.g. the user interface 120 of FIG. 9) for controlling the different electronic apparatus 20 on the touch screen display (e.g. the touch screen display 11 of FIG. 9), the detection value obtained based on a user's input by the electronic apparatus 10 may be in the section ‘a’ 1010. Alternatively, in a situation that the user interface 120 for controlling the different electronic apparatus 20 is displayed on the touch screen display 11, a user may grip the electronic apparatus 10 and then put a finger on the touch input region (e.g. the touch input region 125 of FIG. 9) or the touch input position (e.g. the touch input position 126 of FIG. 9).

According to an embodiment, the electronic apparatus 10 may output the first feedback when it is identified that the detection value is in the section ‘a’ 1010.

The first feedback may for example make the electronic apparatus 10 output a sound based on a sound of content reproduced in the different electronic apparatus 20.

According to an embodiment, the electronic apparatus may obtain information about a sound output from the different electronic apparatus 20. For example, the electronic apparatus 10 may obtain a sound output from the different electronic apparatus 20 in real time. Further, the electronic apparatus 10 may obtain information about the sound volume output from the different electronic apparatus 20. The electronic apparatus 10 may output a obtained sound, which corresponds to the obtained sound volume, as the first feedback. For example, when the obtained sound is higher than 70 dB, the electronic apparatus 10 may output a obtained sound with the maximum volume.

Referring to the reference symbol of ‘10-a’ in FIG. 10, the electronic apparatus 10 may identify that the detection value enters the section ‘b’ 1020. For example, the electronic apparatus 10 may detect that a user puts a finger on the touch input region 125 or the touch input position 126 displayed on the touch screen display 11 and moves the electronic apparatus 10. The electronic apparatus 10 may obtain the detection value based on the detected value, and identify that the obtained detection value enters the section ‘b’ 1020. Alternatively, the electronic apparatus 10 may detect that a user puts a finger on the touch input region 125 or the touch input position 126 displayed on the touch screen display 11 and drags the finger. The electronic apparatus 10 may obtain the detection value based on the detected value and identify that the obtained detection value enters the section ‘b’ 1020.

According to an embodiment, the electronic apparatus 10 may output the second feedback when it is identified that the detection value is in the section ‘b’ 1020.

The second feedback may for example be output based on the first feedback. For example, the electronic apparatus 10 may output a sound with the minimum volume as the second feedback when a sound with the maximum volume is output as the first feedback.

According to an embodiment, the electronic apparatus may identify that the detection value gradually approximates the second threshold in the section ‘b’ 1020. The electronic apparatus 10 may output the second feedback varied depending on change in the detection value. For example, the electronic apparatus 10 may turn the sound volume up. In other words, the electronic apparatus 10 may gradually increase the sound volume according as the detection value is changed into a value approximating the second threshold.

Referring to the reference symbol of ‘10-a’ in FIG. 10, the electronic apparatus 10 may output the third feedback when it is identified that the detection value is in the section ‘c’ 1030.

The third feedback may for example mean change of the second feedback to thereby output the same feedback as the first feedback. For example, the electronic apparatus 10 may output the third feedback by changing the sound volume output as the second feedback into the sound volume output as the first feedback.

The reference symbol of ‘10-b’ in FIG. 10 is the graph illustrating a situation that the electronic apparatus according to various embodiments uses the loudspeaker to output the feedback.

Referring to the reference symbol of ‘10-b’ in FIG. 10, the electronic apparatus 10 may identify that the detection value is in the section ‘a’ 1010.

According to an embodiment, the electronic apparatus 10 may output the first feedback when the detection value is in the section ‘a’ 1010. The first feedback may for example make the electronic apparatus 10 output a sound based on a sound of content reproduced in the different electronic apparatus 20. The electronic apparatus 10 may output a sound obtained in real time from the different electronic apparatus 20, based on the obtained sound volume. For example, when the obtained sound volume is not higher than 40 dB, the electronic apparatus 10 may output a sound with the minimum volume.

Referring to the reference symbol of ‘10-b’ in FIG. 10, the electronic apparatus 10 may identify that the detection value enters the section ‘b’ 1020. According to an embodiment, the electronic apparatus 10 may output the second feedback when it is identified that the detection value is in the section ‘b’ 1020.

The second feedback may for example be generated based on the first feedback. For example, the electronic apparatus 10 may output a sound with the maximum volume as the second feedback when a sound with the minimum volume is output as the first feedback.

According to an embodiment, the electronic apparatus may identify that the detection value gradually approximates the second threshold in the section ‘b’ 1020. The electronic apparatus 10 may output the second feedback varied depending on change in the detection value. For example, the electronic apparatus 10 may turn the sound volume down. In other words, the electronic apparatus 10 may gradually decrease the sound volume output according as the detection value is changed into a value approximating the second threshold.

Referring to the reference symbol of ‘10-b’ in FIG. 10, the electronic apparatus 10 may output the third feedback when it is identified that the detection value is in the section ‘c’ 1030.

The third feedback may for example mean change of the second feedback to output the same feedback as the first feedback. For example, the electronic apparatus 10 may output the third feedback by changing the sound volume output as the second feedback into the sound volume output as the first feedback.

Like this, the electronic apparatus 10 may sequentially output feedback corresponding to a user's input based on a user's input level. Thus, a user may indirectly check whether a process of using the electronic apparatus 10 to control the different electronic apparatus 20 is properly proceeding, based on change in a sound output from the electronic apparatus 10, while keeping viewing the different electronic apparatus 20.

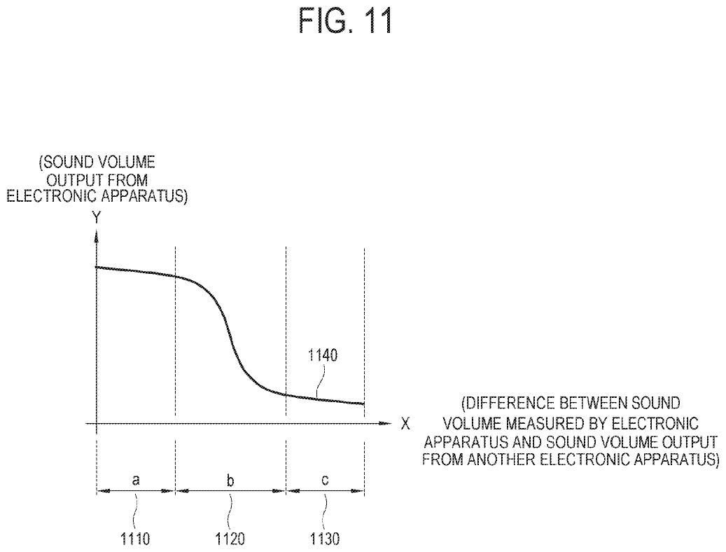

FIG. 11 is a graph illustrating a situation that an electronic apparatus according to an embodiment adjusts a sound volume output as feedback based on difference between a sound volume measured by the electronic apparatus according to an embodiment and a sound volume output from the different electronic apparatus.

Referring to FIG. 11, the X-axis in the graph indicates a difference between a sound volume output from another electronic apparatus (e.g. the different electronic apparatus 20 of FIG. 9) and a value obtained by the electronic apparatus 10 using a microphone that measures the sound output from the different electronic apparatus 20. The Y-axis indicates the sound volume output from the electronic apparatus 10.

According to an embodiment, the electronic apparatus 10 may adjust the sound volume output based on a difference between the sound volume input to the electronic apparatus 10 and the sound volume output from the different electronic apparatus 20 when the loudspeaker is used to output the feedback.

According to an embodiment, the line 1140 in the graph may indicate the sound volume output from the electronic apparatus 10 based on a difference between the sound volume input to the electronic apparatus 10 and the sound volume output from the different electronic apparatus 20.

According to an embodiment, a section ‘a’ 1110 may show a case that the sound volume output from the different electronic apparatus 20 is smaller than the sound volume input to the electronic apparatus 10. In other words, the surroundings around the electronic apparatus 10 may be quieter than those of the different electronic apparatus 20.

In this case, the electronic apparatus 10 may output a sound bigger than the sound output from the different electronic apparatus 20.

According to an embodiment, a section ‘b’ 1120 may show a case that the sound volume output from the different electronic apparatus 20 and the sound volume input to the electronic apparatus 10 are included in a preset range.

In this case, the electronic apparatus 10 may adjust the sound volume output corresponding to the sound volume output from the different electronic apparatus 20. In other words, when the sound volume output from the different electronic apparatus 20 is turned up or down, the electronic apparatus 10 may also turn its output sound volume up or down.

According to an embodiment, a section ‘c’ 1130 shows a case that the sound volume output from the different electronic apparatus 20 is bigger than the sound volume input to the electronic apparatus 10. In other words, the surroundings around the electronic apparatus 10 may be louder than those of the different electronic apparatus 20.

In this case, the electronic apparatus 10 may output a sound smaller than the sound output from the different electronic apparatus 20.

Like this, according to an embodiment of the disclosure, the electronic apparatus 10 may adjust the loudspeaker based on the sound measured by the electronic apparatus 10 and the sound output from the different electronic apparatus 20 when the loudspeaker is used to output the feedback, thereby outputting feedback suitable for the situation to a user.

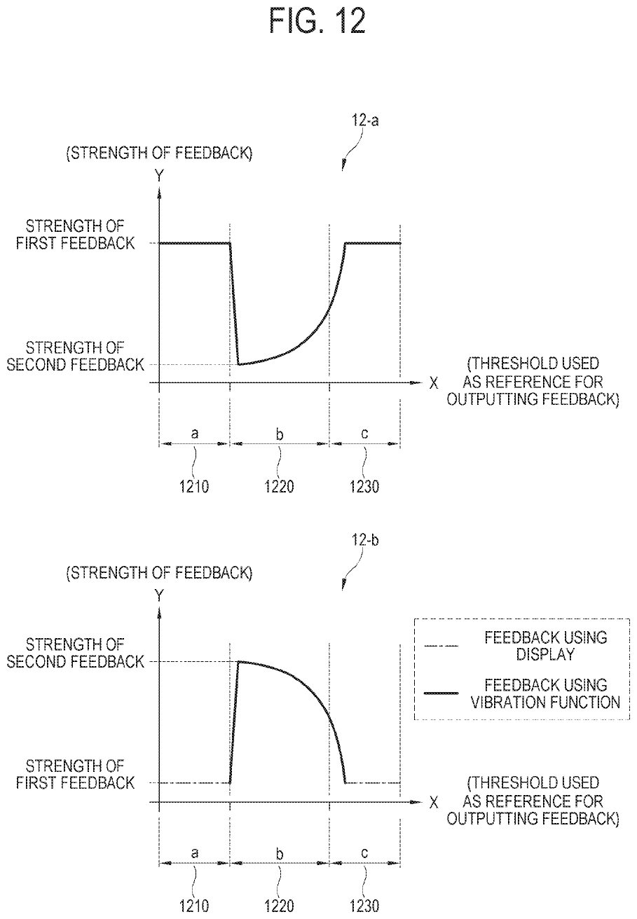

FIG. 12 is a graph illustrating a situation that an electronic apparatus according to an embodiment combines and outputs different kinds of feedback.

Referring to FIG. 12, the X-axis in the graph indicates a threshold used as a reference for outputting various kinds of feedback. The Y-axis indicates intensity (or strength) of feedback output by the electronic apparatus 10.

According to an embodiment, a section ‘a’ 1210 may indicate a section where the detection value is in between ‘0’ and the first threshold, a section ‘b’ 1220 may indicate a section where the detection value is in between the first threshold and the second threshold, and a section ‘c’ 1230 may indicate a section where the detection value is higher than the second threshold. As described above with reference to FIG. 2, the detection value may be a value obtained as a result of detecting a user's input for controlling another electronic apparatus (e.g. the different electronic apparatus 20 of FIG. 9).

Referring to the reference symbol of ‘12-a’ in FIG. 12, the electronic apparatus 10 may identify that the detection value is in the section ‘a’ 1210.

According to an embodiment, the electronic apparatus 10 may output the first feedback when it is identified that the detection value is in the section ‘a’ 1210. The first feedback may for example mean that the electronic apparatus 10 makes vibration of a preset level based on a sound of content reproduced in the different electronic apparatus 20 and at the same time outputs a sound obtained from the different electronic apparatus 20 in real time. For example, when the obtained sound volume is higher than 70 dB, the electronic apparatus 10 may not only make the maximum vibration but also output the obtained sound with the maximum volume.

Referring to the reference symbol of ‘12-a’ in FIG. 12, the electronic apparatus 10 may identify that the detection value enters the section ‘b’ 1220. According to an embodiment, the electronic apparatus 10 may output the second feedback when it is identified that the detection value is in the section ‘b’ 1220.

The second feedback may for example be output based on the first feedback. For example, the electronic apparatus 10 may make the minimum vibration and output a sound with the minimum volume as the second feedback when the maximum vibration is made and a sound with the maximum volume is output as the first feedback.

According to an embodiment, the electronic apparatus may identify that the detection value gradually approximates the second threshold in the section ‘b’ 1220. The electronic apparatus 10 may output the second feedback varied depending on change in the detection value. For example, the electronic apparatus 10 may change the vibration to become stronger and at the same time turn the sound volume up. In other words, the electronic apparatus 10 may gradually increase both the strength of the vibration and the sound volume according as the detection value is changed into a value approximating the second threshold.

Referring to the reference symbol of ‘12-a’ in FIG. 12, the electronic apparatus 10 may output the third feedback when it is identified that the detection value is in the section ‘c’ 1230.

The third feedback may for example mean change of the second feedback to thereby output the same feedback as the first feedback. For example, the electronic apparatus 10 may output the third feedback by changing the strength of the vibration output as the second feedback into the strength of the vibration output as the first feedback and at the same time turning the sound volume output as the first feedback up.

Like this, the electronic apparatus 10 may output both two kinds of feedback to a user. There are no limits to combination of kinds of feedback to be simultaneously output to a user by the electronic apparatus 10.

The reference symbol of ‘12-b’ in FIG. 12 illustrates a situation that the electronic apparatus according to various embodiments combines and outputs different kinds of feedback.

Referring to the reference symbol of ‘12-b’ in FIG. 12, the electronic apparatus 10 may identify that the detection value is in the section ‘a’ 1210.

According to an embodiment, the electronic apparatus 10 may output the first feedback when the detection value is in the section ‘a’ 1210. The first feedback may for example mean that the electronic apparatus 10 displays the same or similar color to the color related to the content, which is reproduced in the different electronic apparatus 20, on the display. In this case, the electronic apparatus 10 may control the display of the electronic apparatus 10 with brightness of a preset level, based on a brightness value measured by the illumination sensor of the electronic apparatus 10 or the brightness value of the display of the different electronic apparatus 20. For example, the electronic apparatus 10 may control the touch screen display (e.g. the touch screen display 11 of FIG. 9) with the minimum brightness value when the brightness value measured by the illumination sensor of the electronic apparatus 10 is lower than or equal to 501ux.

Referring to the reference symbol of ‘12-b’ in FIG. 12, the electronic apparatus 10 may identify that the detection value enters the section ‘b’ 1220. According to an embodiment, the electronic apparatus 10 may output the second feedback when it is identified that the detection value is in the section ‘b’ 1220.

According to an embodiment, the second feedback may be output as feedback different in kind from the first feedback. For example, like the forgoing situation, in a dark situation where an ambient brightness value of the electronic apparatus 10 is lower than or equal to 501ux, the vibration used to output the feedback is suitable for an environment where a user views the different electronic apparatus 20 rather than the display used to output the feedback. In other words, the electronic apparatus 10 may make the vibration of a preset level as the second feedback when the color related to the content is displayed as the first feedback on the display.

According to an embodiment, the electronic apparatus may identify that the detection value gradually approximates the second threshold in the section ‘b’ 1220. The electronic apparatus 10 may output the second feedback varied depending on change in the detection value. For example, the electronic apparatus 10 may change the vibration to become weaker. In other words, the electronic apparatus 10 may gradually decrease the strength of the vibration according as the detection value is changed into a value approximating the second threshold.

Referring to the reference symbol of ‘12-b’ in FIG. 12, the electronic apparatus 10 may output the third feedback when it is identified that the detection value is in the section ‘c’ 1230.

The third feedback may for example mean an output of the same feedback as the first feedback. For example, the electronic apparatus 10 may stop making the vibration output as the second feedback, and output the third feedback by displaying the color related to the content on the display like the first feedback.

According to various embodiments, the electronic apparatus 10 may identify the kind of feedback in consideration of battery-power consumption, performance of a processor, or the like. For example, the electronic apparatus 10 may output feedback to a user by combination of outputting the first feedback and the second feedback with the minimum display brightness to reduce the battery-power consumption, outputting the second feedback with the minimum vibration, and the like method of reducing power consumption.

Like this, according to an embodiment of the disclosure, the electronic apparatus 10 may combine and output a plurality of bunches of feedback to a user based on the situation of the electronic apparatus 10 and the ambient situation of the electronic apparatus 10.

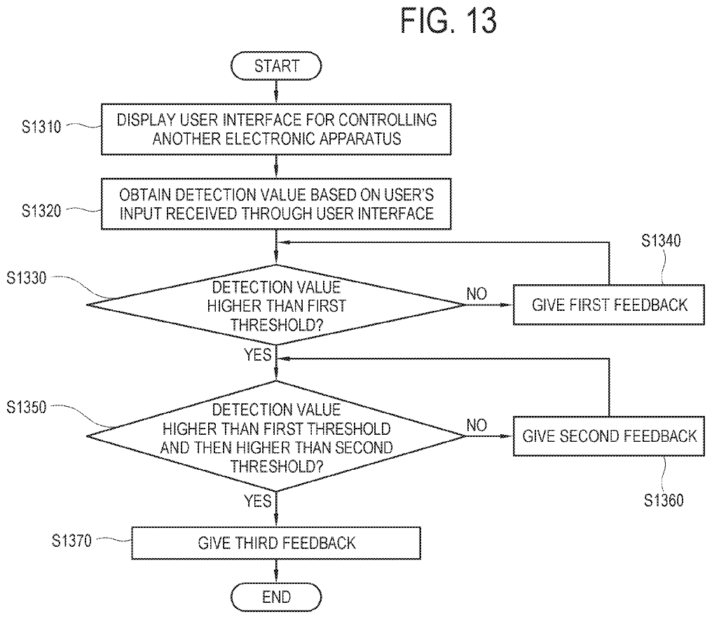

FIG. 13 is a flowchart illustrating a situation that an electronic apparatus according to an embodiment outputs feedback when the electronic apparatus is used to control the different electronic apparatus.

Referring to operation 1310, the electronic apparatus 10 may display the user interface for controlling the different electronic apparatus. For example, the electronic apparatus 10 may execute the remote-control application program to display the user interface for controlling the different electronic apparatus on the display.

Referring to operation 1320, the electronic apparatus 10 may obtain a detection value based on a user's input obtained through the user interface. For example, the electronic apparatus 10 may obtain a detection value based on a user's input using a touch obtaining region included in the user interface. Alternatively, the electronic apparatus 10 may obtain a detection value based on a user' input that touches a certain region of the user interface and moves the electronic apparatus 10.

Referring to operation 1330, the electronic apparatus 10 may identify whether the detection value is higher than the first threshold.

Referring to operation 1340, when the detection value is not higher than the first threshold, the electronic apparatus 10 may output the first feedback. For example, the electronic apparatus 10 may output the first feedback based on information obtained from content reproduced in the different electronic apparatus. The first feedback may for example include at least one of a color displayed through the touch screen display of the electronic apparatus 10, vibration based on the vibration function of the electronic apparatus 10, or a sound using the loudspeaker of the electronic apparatus 10.

Referring to operation 1350, when the detection value is higher than the first threshold, the electronic apparatus 10 may identify whether the detection value is higher than the first threshold and then higher than the second threshold.

Referring to operation 1360, when the detection value is higher than the first threshold but not higher than the second threshold, the electronic apparatus 10 may output the second feedback. For example, the electronic apparatus 10 may output the second feedback against the first feedback. The second feedback may for example be a color complementary to a color expressed as the first feedback. Alternatively, when strong vibration is made as the first feedback, the second feedback may be weak vibration. Alternatively, when a loud sound is output as the first feedback, the second feedback may be a small sound.

According to an embodiment, when the electronic apparatus 10 identifies that the detection value is changed to approximate the second threshold, the second feedback may be changed and output. For example, the electronic apparatus 10 may sequentially change the color expressed as the second feedback into a color similar to the color expressed as the first feedback. Alternatively, the electronic apparatus 10 may gradually decrease the strength of the vibration output as the second feedback. Alternatively, the sound volume output as the second feedback may be gradually turned down.

Referring to operation 1370, when the detection value is higher than the second threshold, the electronic apparatus 10 may output the third feedback. The third feedback may for example be the same feedback as the first feedback.

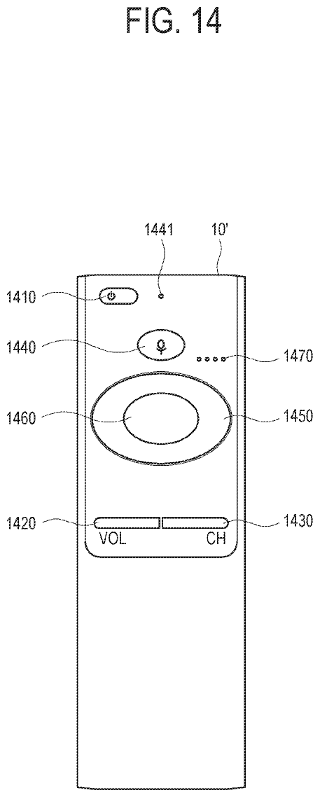

FIG. 14 is a diagram illustrating an electronic apparatus according to an alternative embodiment. The electronic apparatus 10 may be a remote controller for controlling the different electronic apparatus 20.

The electronic apparatus 10 according to this embodiment may include a plurality of input buttons. For example, the electronic apparatus 10 may include a power button 1410 for turning on/off the different electronic apparatus 20, a volume control button 1420 for controlling the sound output volume of the different electronic apparatus 20, a channel changing button 1430 for changing a source of content to be reproduced in the different electronic apparatus 20, and a microphone execution button 1440 for executing a microphone to support a sound input, and may further include a microphone 1441, a wheel button 1450 for selecting another function button and then adjusting the level of the selected function, a color output portion 1460, and a loudspeaker 1470. The electronic apparatus 10 further include a processor (not shown), a sensor module (not shown) and an illumination sensor (not shown).

According to an embodiment, the processor may control general operation of the electronic apparatus 10. For example, the processor may obtain a detection value through a sensor module based on a user's input obtained along with an input at least one button among a plurality of input buttons, output the first feedback when the detection value is lower than the first threshold, output the second feedback when the detection value is higher than the first threshold but lower than the second threshold, and output the third feedback when the detection value is higher than the second threshold.

According to an embodiment, a user may press the volume control button 1420 and control the sound volume while rotating the wheel button 1450 clockwise or counterclockwise. For example, when the wheel button 1450 is rotated clockwise, the sound volume of the different electronic apparatus 20 may be turned up. When the wheel button 1450 is rotated counterclockwise, the sound volume of the different electronic apparatus 20 may be turned down.

According to an embodiment, a user may press the channel changing button 1430 and change the channel while rotating the wheel button 1450 clockwise or counterclockwise. For example, when the wheel button 1450 is rotated clockwise, the number corresponding to the channel may increase. When the wheel button 1450 is rotated counterclockwise, the number corresponding to the channel may decrease.

According to various embodiments, the wheel button 1450 may perform functions of four directional buttons. For example, a user may press the volume control button 1420 and then press an upper or right portion of the wheel button 1450, thereby increasing the sound volume of the different electronic apparatus 20. Alternatively, a user may press the volume control button 1420 and then press a lower or left portion of the wheel button 1450, thereby decreasing the sound volume of the different electronic apparatus 20.

According to various embodiments, a user may press the channel changing button 1430 and then press an upper or right portion of the wheel button 1450, thereby increasing the number corresponding to the channel. Alternatively, a user may press the channel changing button 1430 and then press a lower or left portion of the wheel button 1450, thereby decreasing the number corresponding to the channel.

According to an embodiment, the color output portion 1460 may be provided at the center of the wheel button 1450.

According to various embodiments, a user may control the different electronic apparatus 20 while moving the electronic apparatus 10 in the state that the color output portion 1460 is being pressed (or touched). For example, the electronic apparatus 10 may include a gyro sensor, an acceleration sensor, and the like sensor module for detecting the motion (e.g. movement, rotation, tilting, etc.) of the electronic apparatus 10. When a user moves the electronic apparatus 10 at a predetermined speed or higher while or after pressing the color output portion 1460, the electronic apparatus 10 may select one among the plurality of items based on the detection value obtained by detecting the motion of the electronic apparatus through the sensor module.

The electronic apparatus 10 may output the feedback through the color output portion 1460 based on the color or light described above with reference to FIG. 2.

According to various embodiments, the wheel button 1450 may include opaque or transparent material, and include a color light emitting module (not shown) placed under the wheel button 1450 to express the color. In this case, the electronic apparatus 10 may employ the color output portion 1460 and the wheel button 1450 to output the feedback based on the color or light described above with reference to FIG. 2.

According to an embodiment, the electronic apparatus 10 may include a vibration module (or a haptic module) (not shown). The electronic apparatus 10 may employ the vibration module and a loudspeaker 1470 to output the feedback based on the vibration and sound as described above with reference to FIGS. 7 and 9.

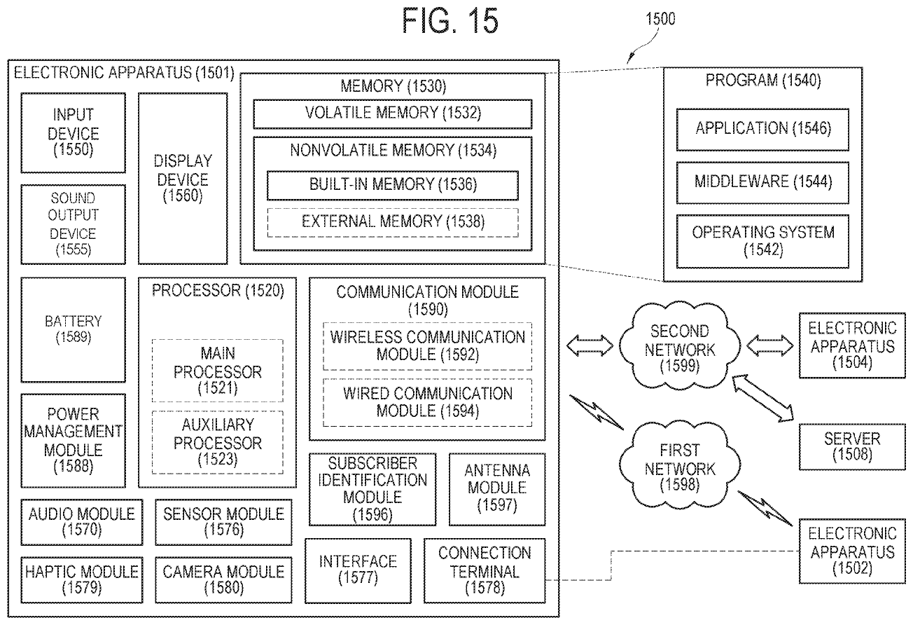

FIG. 15 is a block diagram of an electronic apparatus 1501 in a network environment 1500 according to an alternative embodiment. The electronic apparatus 1501 may include the electronic apparatus 10 of FIG. 1, and the electronic apparatus 10 of FIG. 14. Referring to FIG. 15, under the network environment 1500, the electronic apparatus 1501 may communicate with an electronic apparatus 1502 through a first network 1598 (e.g. a short-range wireless communication network), or may communicate with an electronic apparatus 1504 or a server 1508 through a second network 1599 (e.g. a long-range wireless communication network). According to an embodiment, the electronic apparatus 1501 may communicate with the electronic apparatus 1504 through the server 1508. According to an embodiment, the electronic apparatus 1501 may include a processor 1520, a memory 1530, an input device 1550, a sound output device 1555, a display device 1560, an audio module 1570, a sensor module 1576, an interface 1577, a haptic module 1579, a camera module 1580, a power management module 1588, a battery 1589, a communication module 1590, a subscriber identification module 1596, or an antenna module 1597. According to an exemplary embodiment, the electronic apparatus 1501 may exclude at least one (e.g. the display device 1560 or the camera module 1580) from these elements, or include one or more additional elements. According to an exemplary embodiment, some among these elements may be actualized as a single integrated circuit. For example, the sensor module 1576 (e.g. a fingerprint sensor, an iris sensor, or an illumination sensor) may be embedded in the display device 1560 (e.g. the display).

The processor 1520 may for example execute software (e.g. a program 1540) to control at least one of other elements (e.g. hardware or software elements) of the electronic apparatus 1501 connected to the processor 1520 and perform various data processes or calculations. According to an embodiment, as at least a part of the data process or calculation, the processor 1520 may load a command or data obtained from other elements (e.g. the sensor module 1576 or the communication module 1590) to the volatile memory 1532, process the command or data stored in the volatile memory 1532, and store result data in the nonvolatile memory 1534. According to an embodiment, the processor 1520 may include a main processor 1521 (e.g. a central processing unit (CPU) or an application processor), and an auxiliary processor 1523 (e.g. a graphic processor, an image signal processor, a sensor hub processor, or a communication processor) operable independently of or along with the main processor 1521. Additionally or alternatively, the auxiliary processor 1523 may use lower power than the main processor 1521, or may be specified for a designated function. The auxiliary processor 1523 may be actualized separately from or as a part of the main processor 1521.

The auxiliary processor 1523 may for example control at least one of functions or states related to at least one element (e.g. the display device 1560, the sensor module 1576, or the communication module 1590) among the elements of the electronic apparatus 1501, instead of the main processor 1521 while the main processor 1521 is in an inactive mode (e.g. a sleep mode), or along with the main processor 1521 while the main processor 1521 is an active mode (e.g. an application running mode). According to an embodiment, the auxiliary processor 1523 (e.g. an image signal processor or a communication processor) may be actualized as a part of another functionally-related element (e.g. the camera module 1580 or the communication module 1590).

The memory 1530 may be configured to store various pieces of data used by at least one element (e.g. the processor 1520 or the sensor module 1576) of the electronic apparatus 1501. The data may for example software (e.g. a program 1540) and input or output data about commands related to the software. The memory 1530 may include the volatile memory 1532 or the nonvolatile memory 1534.

The program 1540 may be stored as the software in the memory 1530, and for example include an operating system 1542, middleware 1544 or an application 1546.

The input device 1550 may obtain a command or data to be used in the elements (e.g. the processor 1520) of the electronic apparatus 1501 from the outside (e.g. a user) of the electronic apparatus 1501. The input device 1550 may for example include a microphone, a mouse or a keyboard.

The sound output device 1555 may output a sound signal to the outside of the electronic apparatus 1501. The sound output device 1555 may for example include a loudspeaker or a receiver. The loudspeaker may be used for general purposes such as multimedia reproduction or recording reproduction, and the receiver may be used for receiving a call. According to an embodiment, the receiver may be actualized separately from or as a part of the loudspeaker.

The display device 1560 may visually provide information to the outside (e.g. a user) of the electronic apparatus 1501. The display device 1560 may for example include a display, a hologram device or a projector, and a control circuit for controlling the device. According to an embodiment, the display device 1560 may include a touch circuit configured to detect a touch, or a sensor circuit (e.g. a pressure sensor) configured to measure the strength of the touch.

The audio module 1570 may convert a sound into an electric signal or an electric signal into a sound. According to an embodiment, the audio module 1570 may obtain a sound through the input device 1550, or may output a sound through the external electronic apparatus (e.g. the electronic apparatus 1502) directly or wirelessly connected to the sound output device 1555 or the electronic apparatus 1501 (e.g. a loudspeaker or a headphone).

The sensor module 1576 may detect an operation mode (e.g. power or temperature) of the electronic apparatus 1501 or environmental conditions of the outside (e.g. a user's state), and generate an electric signal or a data value corresponding to the detection. According to an embodiment, the sensor module 1576 may for example include a gesture sensor, a gyro sensor, an atmospheric sensor, a magnetic sensor, an acceleration sensor, a grip sensor, a proximity sensor, a color sensor, an infrared sensor, a biometric sensor, a temperature sensor, a humidity sensor, or an illumination sensor.

The interface 1577 may support one or more designated protocols for direct or wireless connection between the electronic apparatus 1501 and the external electronic apparatus (e.g. the electronic apparatus 1502). According to an embodiment, the interface 1577 may for example include a high definition multimedia interface (HDMI), a universal serial bus (USB) interface, an SD card interface, or an audio interface.

A connection terminal 1578 may include a connector though which the electronic apparatus 1501 can physically connect with the external electronic apparatus (e.g. the electronic apparatus 1502). According to an embodiment, the connection terminal 1578 may for example include an HDMI connector, a USB connector, an SD card connector, or an audio connector (e.g. a headphone connector).

The haptic module 1579 may convert an electric signal into a mechanical stimulus (e.g. the vibration or the motion) recognizable by a user through tactile sensation or movement sensation. According to an embodiment, the haptic module 1579 may for example include a motor, a piezoelectric device, or an electric stimulus device.

The camera module 1580 may capture a still image and a moving image. According to an embodiment, the camera module 1580 may include one or more lenses, image sensors, image signal processors, or flashes.

The power management module 1588 may manage power supplied to the electronic apparatus 1501. According to an embodiment, the power management module 1588 may for example be actualized as at least a part of power management integrated circuit (PMIC).

The battery 1589 may supply power to at least one element of the electronic apparatus 1501. According to an embodiment, the battery 1589 may for example include a non-rechargeable primary cell, a rechargeable secondary cell or a fuel cell.

The communication module 1590 may include a communication interface that supports establishment of a direct (e.g. wired) communication channel or a wireless communication channel between the electronic apparatus 1501 and the external electronic apparatus (e.g. the electronic apparatus 1502, the electronic apparatus 1504, or the server 1508), and communication using the established communication channel. The communication module 1590 may include one or more communication processor operating independently of the processor 1520 (e.g. the application processor), and supporting the direct (e.g. wired) communication or wireless communication. According to an embodiment, the communication module 1590 may include a wireless communication module and/or interface 1592 (e.g. a cellular communication module, a short-range wireless communication module, or a global navigation satellite system (GNSS) communication module) or a wired communication module or interface 1594 (e.g. a LAN communication interface, or a power line communication interface). Among these communication modules, a corresponding communication module or interface may communicate with the external electronic apparatus through the first network 1598 (e.g. the short range communication network such as Bluetooth, Wi-Fi direct or IrDA) or the second network 1599 (e.g. the long-range communication network such as a cellular network, an Internet, or a computer network (e.g. LAN or WAN). Various such communication modules may be integrated into one element (e.g. a single chip), or may be individually provided as a plurality of elements (e.g. a plurality of chips). The wireless communication module 1592 may ascertain and authenticate the electronic apparatus 1501 within the communication network such as the first network 1598 or the second network 1599 based on subscriber information (e.g. international mobile subscriber identity (IMSI) stored in the subscriber identification module 1596.

The antenna module 1597 may include an antenna that transmits a signal or power to the outside (e.g. the external electronic apparatus) or obtains a signal or power from the outside. According to an embodiment, the antenna module or interface 1597 may include one or more antennas, and thus at least one antenna suitable for the communication used in the communication network such as the first network 1598 or the second network 1599 may for example be selected by the communication module 1590. The signal or power may be transmitted or obtained between the communication module 1590 and the external electronic apparatus through at least one selected antenna.

At least some among the foregoing elements are connected to each other and exchange a signal (e.g. a command or data) through a communication type between peripheral devices (e.g. a bus, a general-purpose input and output (GPIO), a serial peripheral interface (SPI), or mobile industry processor interface (MIPI)).

According to an embodiment, the command or the data may be transmitted or obtained between the electronic apparatus 1501 and the external electronic apparatus 1504 through the server 1508 connected to the second network 1599. Each of the electronic apparatuses 1502 and 1504 may be the same as or different from the electronic apparatus 1501. According to an embodiment, all or a part of the operation executed in the electronic apparatus 1501 may be executed in one or more external apparatuses among the external electronic apparatuses 1502, 1504 and 1508. For example, when the electronic apparatus 1501 has to perform a certain function or service automatically or in response to a request of a user or another apparatus, the electronic apparatus 1501 may make a request for the function or service to one or more external electronic apparatuses, instead of or in addition to autonomously executing the function or service. One or more external electronic apparatuses obtaining the request may execute at least a part of the requested function or service, or an additional function or service related to the request, and transmit a result of the execution to the electronic apparatus 1501. The electronic apparatus 1501 may directly or additionally process the result, and provide at least a part of a response to the request. To this end, a cloud computing, distributed computing, or client-server computing technique may for example be employed.

Various embodiments of the disclosure may be actualized the software (e.g. the program 1540) including one or more instructions stored in a storage medium (e.g. a built-in memory 1536 or an external memory 1538), which is readable by a machine (e.g. the electronic apparatus 1501). For example, the processor (e.g. the processor 1520) of the machine (e.g. the electronic apparatus 1501) calls at least one instruction among one or more stored instructions from the storage medium, and executes a command corresponding to the one or more instructions. This makes the machine operate to perform at least one function in response to at least one called command. The one or more commands may include a code generated by a compiler or a code executable by an interpreter. The machine-readable storage medium may be provided in the form of a non-transitory storage medium. Here, the term ‘non-transitory’ means that the storage medium is tangible and does not include a signal (e.g. an electromagnetic wave), without distinguishing between a case where the data is semi-permanently stored in the storage medium and a case where the data is temporarily stored.

According to an embodiment, the method according to various embodiments of the disclosure may be provided as involved in a computer program product. The computer program product may be traded as goods between a seller and a buyer. The computer program product may be distributed in the form of the machine-readable storage medium (e.g. a compact disc read only memory (CD-ROM)), or direct, online distribution (downloading or uploading) between two user devices (e.g. smartphones) through an application store (e.g. a Play Store™). In a case of the online distribution, at least a part of the computer program product may be at least temporarily stored in the machine-readable storage medium such as a memory of a relay server, a server of the application store, or a server of a manufacturer, or may be provisionally generated.

According to various embodiments, the elements of the foregoing elements (e.g. a module or a program) may include a single or a plurality of objects. According to various embodiments, one or more elements among the foregoing elements or operation may be omitted, or one or more other elements or operation may be added. Alternatively or additionally, the plurality of elements (e.g. modules or programs) may be integrated into one element. In such a case, the integrated element may perform the same or similar functions as those performed by the corresponding elements among the plurality of elements before one or more functions of individual elements among the plurality of elements are integrated. According to various embodiments, operations performed by the module, the program or other elements may be carried out in sequence, in parallel, repetitively, or heuristically, or one or more among the operations may be executed in different order, be omitted or include one or more other operations.

According to the disclosure, the electronic apparatus may detect a user's input desired to control another electronic apparatus and output various bunches of feedback to a user based on levels of a user's input.

According to the disclosure, the electronic apparatus may output the feedback to a user through the touch screen display.

According to the disclosure, the electronic apparatus may output feedback to a user through a vibration function.

According to the disclosure, the electronic apparatus may output feedback to a user through a loudspeaker.

Although a few embodiments have been shown and described, it will be appreciated by those skilled in the art that changes may be made in these embodiments without departing from the principles and spirit of the invention, the scope of which is defined in the appended claims and their equivalents.

What is claimed is:

1. An electronic apparatus comprising:
a touch screen display;
a communication interface;
a processor; and
a memory configured to store instructions that, when executed, cause the processor to:
control the touch screen display to display a user interface for a guide to control a different electronic apparatus connected via the communication interface,
obtain a detection value via the touch screen display based on a user's input obtained using the user interface, and
output first feedback based on the detection value being lower than a first threshold, second feedback based on the detection value being higher than the first threshold but lower than a second threshold, and third feedback based on the detection value being higher than the second threshold.

2. The electronic apparatus according to claim 1, wherein the instructions cause the processor to control the communication interface to transmit a signal corresponding to the user's input to a different electronic apparatus based on the detection value being higher than the second threshold.

3. The electronic apparatus according to claim 1, wherein the instructions cause the processor to obtain information related to content reproduced by the different electronic apparatus and output the first feedback, the second feedback, and the third feedback.

4. The electronic apparatus according to claim 3, wherein the instructions cause the processor to:
obtain information about a genre of the content reproduced by the different electronic apparatus; and
control the touch screen display to perform at least one of:
output the first feedback based on a preset color corresponding to the obtained information about the genre;
output the second feedback based on a color complementary to the preset color; or
output the third feedback based on the preset color.

5. The electronic apparatus according to claim 4, wherein the instructions cause the processor to output a color while changing a color output as the second feedback into a color similar to the color output as the first feedback, based on the detection value approximating the second threshold.

6. The electronic apparatus according to claim 4, wherein
the electronic apparatus further comprises an illumination sensor, and
the instructions cause the processor to output at least one among the first feedback, the second feedback, and the third feedback by adjusting a brightness value of the touch screen display based on brightness information obtained through the illumination sensor.

7. The electronic apparatus according to claim 3, wherein
the electronic apparatus further comprises a haptic feedback module, and
the instructions cause the processor to: obtain information about a sound volume output while the different electronic apparatus reproduces content; and
controlling the haptic feedback module to perform at least one of:
output vibration having a preset strength corresponding to the obtained information about the sound volume, as the first feedback;
output vibration having a strength different from the preset strength, as the second feedback; or
output vibration having the preset strength, as the third feedback.

8. The electronic apparatus according to claim 7, wherein the instructions cause the processor to output vibration while changing the vibration output as the second feedback into vibration having similar strength to the vibration output as the first feedback, based on the detection value approximating the second threshold.

9. The electronic apparatus according to claim 3, wherein the electronic apparatus further comprises a loudspeaker,
the instructions cause the processor to
obtain information about a sound and a sound volume output while the different electronic apparatus reproduces content; and
control the loudspeaker to perform at least one of:
outputting the obtained sound with a preset sound volume corresponding to the obtained sound volume, as the first feedback;
outputting the obtained sound with a sound volume different from the preset sound volume, as the second feedback; or
outputting the obtained sound with the preset volume, as the third feedback.

10. The electronic apparatus according to claim 9, wherein the instructions cause the processor to output the obtained sound while changing the obtained sound output as the second feedback to have a similar sound volume to the obtained sound output as the first feedback, based on the detection value approximating the second threshold.

11. A method of controlling an electronic apparatus, comprising:
displaying a user interface for a guide to control a different electronic apparatus on a touch screen display;
obtain a detection value, via the touch screen display, based on a user's input obtained using the user interface; and
outputting first feedback based on the detection value being lower than a first threshold, second feedback based on the detection value being higher than the first threshold but lower than a second threshold, and third feedback based on the detection value being higher than the second threshold.

12. The method according to claim 11, further comprising obtaining information related to content reproduced by the different electronic apparatus and outputting the first feedback, the second feedback, and the third feedback.

13. The method according to claim 12, further comprising:
obtaining information about a genre of the content reproduced by the different electronic apparatus; and
controlling the touch screen display to perform at least one of:
outputting the first feedback based on a preset color corresponding to the obtained information about the genre;
outputting the second feedback based on a color complementary to the preset color; and
outputting the third feedback based on the preset color.

14. The method according to claim 12, further comprising
outputting a color while changing a color output as the second feedback into a color similar to the color output as the first feedback, based on the detection value approximating the second threshold.

15. The method according to claim 13, wherein the electronic apparatus further comprises an illumination sensor, and
the method comprises outputting the feedback by adjusting a brightness value of the touch screen display based on brightness information obtained through the illumination sensor.

16. The method according to claim 12, wherein
the electronic apparatus further comprises a haptic feedback module, and
the method comprises:
obtaining information about a sound volume output while the different electronic apparatus reproduces content; and
controlling the haptic feedback module to perform at least one of:
outputting vibration having a preset strength corresponding to the obtained information about the sound volume, as the first feedback;
outputting vibration having a strength different from the preset strength of the vibration, as the second feedback; or
outputting vibration having the preset strength, as the third feedback.

17. The method according to claim 14, further comprising outputting vibration while changing the vibration output as the second feedback into vibration having similar strength to the vibration output as the first feedback, based on the detection value approximating the second threshold.

18. The method according to claim 12, wherein
the electronic apparatus further comprises a loudspeaker, and
the method comprises:
obtaining information about a sound and a sound volume output while the different electronic apparatus reproduces content; and
controlling the loudspeaker to perform at least one of:
output the obtained sound with a preset sound volume corresponding to the obtained sound volume, as the first feedback;
outputting the obtained sound with a sound volume different from the preset sound volume, as the second feedback; and
outputting the obtained sound with the preset volume, as the third feedback.

19. The method according to claim 18, further comprising outputting the obtained sound while changing the obtained sound output as the second feedback to have a similar sound volume to the obtained sound output as the first feedback, based on the detection value approximating the second threshold.

20. An electronic apparatus comprising:
a communication interface;
a sensor;
a plurality of input buttons; and
a processor configured to:
obtain a detection value via the sensor based on a user's input obtained by the sensor along with an input of at least one button among the plurality of input buttons, and
output first feedback based on the detection value being lower than a first threshold, second feedback based on the detection value being higher than the first threshold but lower than a second threshold, and third feedback based on the detection value being higher than the second threshold.
